(19) United States
(12) Patent Application Publication
(10) Pub. No.: US 2011/0202177 A1
(43) Pub. Date: Aug. 18, 2011

(54) Intuitive Graphical User Interface for Carrying Out Chemical Reactions

(75) Inventors: Arkadij M. Elizarov, Woodland Hills, CA (US); Carroll Edward Ball, Los Angeles, CA (US); Ansgar Graw, Chicago, IL (US); Hartmuth C. Kolb, Playa Del Rey, CA (US); Uttam D. Shah, Torrance, CA (US)

(73) Assignee: SIEMENS MEDICAL SOLUTIONS USA, INC., Malvern, PA (US)

(21) Appl. No.: 13/027,465

(22) Filed: Feb. 15, 2011

Related U.S. Application Data
(60) Provisional application No. 61/304,610, filed on Feb. 15, 2010.

(51) Int. Cl. G05B 21/02

(52) U.S. Cl. 700/268

(57) ABSTRACT

An apparatus and method for chemical synthesis, the method includes accessing a recipe, the recipe including a sequence of one or more processing steps for the chemical synthesis. The processing steps including one or more steps. The recipe is executed by sorting the processing steps and executing the one or more selected steps prior to executing other steps. The chemical synthesis is monitored by providing status data, indicating a status of the execution and enabling input of control data to modify execution based on the status data or user-initiated modification. Information related to the status of the execution is displayed, typically as a graphical representation of a process action.

### CLAIM TO PRIORITY

The present application claims priority to U.S. provisional application No. 61/304,610, filed Feb. 15, 2010, which is hereby incorporated by reference in its entirety herein.

The foregoing application, and all documents cited therein or during their prosecution (“appln cited documents”) and all documents cited or referenced in the appln cited documents, and all documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

### BACKGROUND

1. Field of the Invention

The present invention relates generally to devices for carrying out reactions such as synthesizing chemicals. Such synthesizing devices may be microfluidic chips. Such chemicals may be radioactive compounds for use in positron emission tomography (PET). More specifically, the present invention relates to a computer program, software and interface that allow a user to efficiently interact with and control substantially all components of the microfluidic chip.

2. Background Discussion

F-18-FDG is a radioactive compound that may be used in PET. It may be produced in microfluidic reactors and/or macrofluidic reactors such as those shown in PCT/US2008/060267; the full disclosure of which is incorporated by reference herein. PCT/US2008/060267 describes a microfluidic device or chip that comprises “hardware” such as valves, one or more reaction chambers, an ion exchange column, HPLC, filters, vents, a reagent source in fluid communication with the chip, a gas and fluid delivery and removal network and localized radiation shielding for shielding critical components of the device.

The general operation of a microfluidic chip, such as that shown in PCT/US2008/060267 may be as follows. First, target water is passed through an ion exchange cartridge to trap F-18 out of a dilute solution. K₂CO₃ may then be released into a concentrated solution that enters the reactor. Next, K222/MeCN solution may be delivered. After the reagents have mixed, nitrogen may be delivered. Solvents evaporate quickly leaving behind a residue containing an F-18 KF/K222 complex. Next, the precursor (mannose triflate) may be delivered to the reactor.

The resulting reaction mixture may be heated, allowing it to boil for a few seconds to achieve mixing. The residue is usually then re-dissolved. Next, the reaction mixture may be superheated to about 140° C. After cooling, the solvent is evaporated by the flow of nitrogen. Deprotection is then carried out by bringing ethanolic HCl into the reactor. Once again, the reaction mixture may be heated. Then, the solvents may be evaporated, leaving behind a residue of FDG. The final step of product elution takes place when water enters the reactor from one channel and carries the products out of another channel.

The above steps may be facilitated by mechanical movement of the hardware of the synthesis system; for example, by various opening and closing of valves. To operate the system, and carry out the above-described process, the user; usually a chemist, must operate each component of the system. Thus, he or she must worry about turning a valve on or off, increasing or decreasing the temperature, loading a certain concentration of reagent, etc. This distracts from the chemists efforts in making sure that the desired reaction is carried out properly. In addition, while chemists are experts in understanding the “recipe” for the synthesis (i.e., they know what radiopharmaceutical is needed, at what temperature the reaction should be run, etc.), they may not be well-trained in the operation of the hardware systems of the chip. Further, without engineering training, it may take some time for the chemists to be fully efficient at operating the systems. Similarly, often times, they must learn how to operate each individual component of the system, which is difficult to learn because these components may operate very differently.

### SUMMARY

It is noted that in this disclosure and particularly in the claims and/or paragraphs, terms such as “comprises”, “comprised”, “comprising” and the like can have the meaning attributed to it in U.S. Patent law; e.g., they can mean “includes”, “included”, “including”, and the like; and that terms such as “consisting essentially of” and “consists essentially of” have the meaning ascribed to them in U.S. Patent law, e.g., they allow for elements not explicitly recited, but exclude elements that are found in the prior art or that affect a basic or novel characteristic of the invention.

Accordingly, one embodiment of the present invention is directed to a non-transitory computer-readable medium storing a program that when executed performs a method for chemical synthesis (“the method”). The method includes accessing a recipe, the recipe including a sequence of one or more processing steps for the chemical synthesis. The processing steps including one or more pre-isotope steps and one or more post-isotope steps. The recipe is executed by sorting the processing steps; and executing the one or more pre-isotope steps prior to the one or more post-isotope steps. The method also includes monitoring the chemical synthesis; providing status data, indicating a status of the execution; enabling input of control data to modify execution based on the status data or user-initiated modification; and displaying information related to the status of the execution, that includes at least one graphical representation of a process action.

Another embodiment of the present invention is directed to the method described above and also includes accessing one or more user-defined parameters for the recipe.

Another embodiment of the present invention is directed to the method described above, wherein the monitoring step further includes sensing one or more conditions of the chemical synthesis.

Another embodiment of the present invention is directed to the method described above, wherein the control data includes response data to one or more pre-selected questions.

Another embodiment of the present invention is directed to the method described above, wherein the control data includes responses to instructions displayed for a user to execute.

Another embodiment of the present invention is directed to the method described above, wherein sorting the process steps is performed prior to execution of any process step.

Another embodiment of the present invention is directed to the method described above and also includes displaying a drop-down menu that provides additional recipe parameters.

Another embodiment of the present invention is directed to the method described above, wherein the recipe is modified based on the additional recipe parameters.

Another embodiment of the present invention is directed to the method described above, and also includes displaying the process of the modified recipe.

Another embodiment of the present invention is directed to the method described above, and also includes accessing a ratio of solvents and executing an operation for creating a mixture of chemicals at one or more time intervals.

Another embodiment of the present invention is directed to the method described above, wherein the chemical synthesis a radiosynthesis system.

Another embodiment of the present invention is directed to the method described above, wherein the chemical synthesis a microfluidic system.

Another embodiment of the present invention is directed to the method described above, and also includes detecting a code on a consumable package; and selecting a recipe to execute based on the code.

Another embodiment of the present invention is directed to the method described above, and also includes selecting a recipe to execute from a list of at least one recipe displayed on a graphical user interface.

Another embodiment of the present invention is directed to the method described above, and also includes calculating at least one yield of the chemical synthesis, wherein the yield calculation includes reactor detector readings from one or more processing steps.

Another embodiment of the present invention is directed to the method described above, and also includes compiling the recipe based on at least one user-entered answer to one or more chemistry-related questions; verifying that the recipe does not contain conflicting processes; and storing the recipe after verification.

Another embodiment of the present invention is directed to the method described above, and also includes optimizing the recipe to run two or more processing steps in parallel, wherein the processing steps are synchronized so that the parallel processing steps complete substantially simultaneously.

Another embodiment of the present invention is directed to the method described above, and also includes performing a cleaning step of cleaning portions of chemical synthesis apparatus, wherein the cleaning step cleans only those portions of the chemical synthesis apparatus that performed processing steps.

Another embodiment of the present invention is directed to the method described above, and also includes mixing at least two reagents, wherein the reagents are mixed in proportions according to the recipe.

Another embodiment of the present invention is directed to the method described above, and also includes priming one or more reagents prior to an associated processing step that utilizes the reagent, wherein the primed reagent is available for the chemical synthesis for the associated processing step.

Another embodiment of the present invention is directed to the method described above, and also includes storing a subset of the information related to the status of the execution; calculating performance information from the stored information; and displaying the calculated performance information.

Another embodiment of the present invention is directed to the method described above, and also includes transmitting real-time video data from a chemical synthesis module to a display module.

Another embodiment of the present invention is directed to the method described above, and also includes providing instructions to a user at a selected processing step requesting one or more actions by the user.

Another embodiment of the present invention is directed to the method described above, and also includes detecting an alert condition; and displaying an alert indication.

Another embodiment of the present invention is directed to the method described above, and also includes detecting a radiation level during execution of the recipe; terminating execution of the recipe when the detected radiation level exceeds a predetermined threshold; and displaying an alert indication.

Another embodiment of the present invention is directed to the method described above, and also includes running a self-test to confirm execution of the recipe is appropriate.

Another embodiment of the present invention is directed to the method described above, and also includes transmitting a communication related to execution of the recipe over a network.

Another embodiment of the present invention is directed to the method described above, and also includes monitoring the usage of at least one consumable; and generating an alert indication when the amount of available consumable is below a predetermined threshold.

Another embodiment of the present invention is directed to an electronic storage medium storing a program that when executed performs a method for chemical synthesis, (“the chemical synthesis method”). The chemical synthesis method includes accessing a recipe, the recipe including a sequence of one or more processing steps for the chemical synthesis, executing the recipe by sorting the processing steps into one or more pre-isotope steps and one or more post-isotope steps; monitoring the chemical synthesis; providing status data, indicating a status of the execution; enabling input of control data to modify execution based on the status data or user-initiated modification; and displaying information related to the status of the execution, that includes at least one graphical representation of a process action.

Another embodiment of the present invention is directed toward the chemical synthesis method and also includes introducing one or more additional isotope steps.

Another embodiment of the present invention is directed toward the chemical synthesis method and also includes displaying information relevant to a currently occurring operational step of the chemical synthesis.

Another embodiment of the present invention is directed toward the chemical synthesis method and also includes displaying information relevant to control of a currently occurring operational step of the chemical synthesis.

Another embodiment of the present invention is directed toward the chemical synthesis method and also includes determining performance of the execution; and comparing the performance of the execution to a performance value of a previous execution of the same method.

Another embodiment of the present invention is directed toward the chemical synthesis method and also includes displaying the information related to the status of the execution on a second display device.

Another embodiment of the present invention is directed toward the chemical synthesis method and also includes displaying one or more control inputs to a user; and utilizing the control input during the execution.

Another embodiment of the present invention is directed toward the chemical synthesis method, wherein the one or more control inputs displayed to the user are based on an authorization level of the user.

Another embodiment of the present invention is directed to a non-transitory computer-readable medium storing a program that when executed performs a method for chemical synthesis, that includes accessing a recipe, the recipe including a sequence of one or more processing steps and user input for the chemical synthesis, executing the recipe by:

identifying one or more triggering events; and

sorting the user input into pre-triggering and post-triggering events;

executing the pre-triggering steps prior to the post-triggering events;

monitoring the chemical synthesis; providing status data, indicating a status of the execution; enabling input of control data to modify execution based on the status data or user-initiated modification; and displaying information related to the status of the execution. Another embodiment is directed to sorting the processing steps, based on the status of the triggering event. In other words, the presence of a triggering event will determine the sequence of processing. In another embodiment, the triggering step is necessary prior to execution of other steps.

Another embodiment of the present invention is directed to a system for displaying a status of a process that includes one or more components; one or more conduit paths connecting one or more of the first components, the conduit paths providing a conduit for fluid; one or more sensors, each sensor corresponding to an associated component, the sensors sensing when fluid is present at the component and providing a status signal;

A processor, operatively coupled to receive the status signals from the sensors and process the received status signals; and a display unit, operatively coupled to the processor to display a graphical representation of the status signals showing a path of fluid flow through the conduit paths.

These and other embodiments of the present invention are disclosed or are apparent from and encompassed by the following Detailed Description when taken in conjunction with the accompanying drawings.

### BRIEF DESCRIPTION OF THE DRAWINGS

To the accomplishment of the foregoing and related ends, certain illustrative embodiments of the invention are described herein in connection with the following description and the annexed drawings. These embodiments are indicative, however, of but a few of the various ways in which the principles of the invention may be employed and the present invention is intended to include all such aspects and their equivalents. Other advantages, embodiments and novel features of the invention may become apparent from the following description of the invention when considered in conjunction with the drawings. The following description, given by way of example, but not intended to limit the invention solely to the specific embodiments described, may best be understood in conjunction with the accompanying drawings, in which:

FIG. 1 illustrates an example of a network that supports embodiments of the present invention.

FIG. 2 illustrates an example of a processing apparatus according to an embodiment of the present invention.

FIG. 3 shows another example of a processing apparatus according to the present invention.

FIG. 4 shows an example of an algorithm according to an embodiment of the present invention.

FIG. 5 shows another example of an algorithm according to an embodiment of the present invention.

FIGS. 6-35 show examples of screen shots of execution of chemical synthesis according to an embodiment of the present invention.

FIG. 36 illustrates an exemplary schematic and graphs of chemical synthesis according to an embodiment of the present invention.

FIG. 37 illustrates an exemplary display of device calibration according to an embodiment of the present invention.

FIG. 38 illustrates an example of a screen shot according to an embodiment of the present invention.

FIG. 39 shows an example of a chemical reaction (recipe) editing screen according to an embodiment of the present invention.

FIG. 40 illustrates an example of a screen shot according to an embodiment of the present invention.

FIG. 41 illustrates an example of a screen shot of a view of UV spectrum according to an embodiment of the present invention.

FIG. 42 shows a series of steps according to an embodiment in which a triggering event is used to execute a recipe.

FIG. 43 shows a series of steps according to another embodiment in which a triggering event is used to execute a recipe.

### DETAILED DESCRIPTION

It is noted that in this disclosure and particularly in the claims and/or paragraphs, terms such as “comprises,” “comprised,” “comprising,” and the like can have the meaning attributed to it in U.S. patent law; that is, they can mean “includes,” “included,” “including,” “including, but not limited to” and the like, and allow for elements not explicitly recited. Terms such as “consisting essentially of” and “consists essentially of” have the meaning ascribed to them in U.S. patent law; that is, they allow for elements not explicitly recited, but exclude elements that are found in the prior art or that affect a basic or novel characteristic of the invention. These and other embodiments are disclosed or are apparent from and encompassed by, the following description. As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

Furthermore, the detailed description describes various embodiments of the present invention for illustration purposes and embodiments of the present invention include the methods described and may be implemented using one or more apparatus, such as processing apparatus coupled to electronic media. Embodiments of the present invention may be stored on an electronic media (electronic memory, RAM, ROM, EEPROM) or programmed as computer code (e.g., source code, object code or any suitable programming language) to be executed by one or more processors operating in conjunction with one or more electronic storage media.

As stated above, the present invention is directed to a content providing system that includes, for example, processing devices, hand held electronic devices, computers, tablets on-demand gaming devices that may include a handheld console, and/or similar device with processing capability, that can be used for providing content, such as on-demand casual games or applications or electronic media, on-line books, audio data, video data, movies, image data and other electronic content to users.

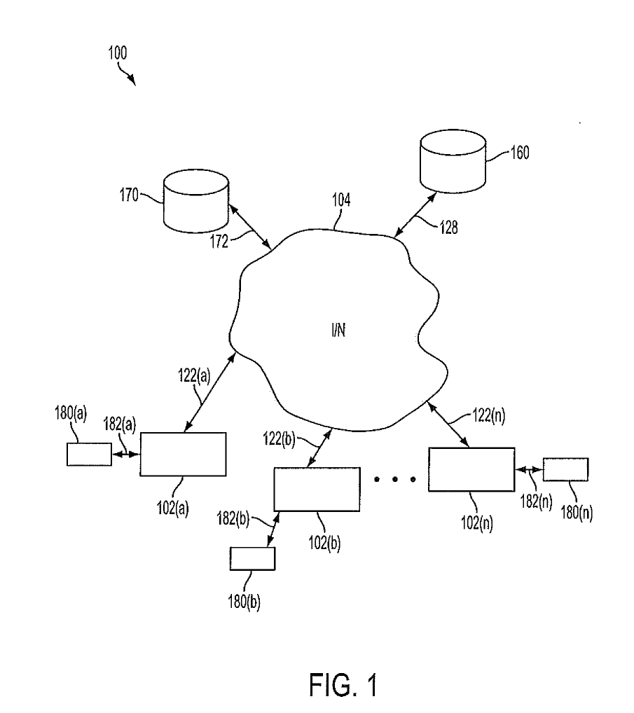

FIG. 1 illustrates an example 100 of a network that supports embodiments of the present invention.

Embodiments of the present invention may be implemented using one or more processing devices, or processing modules or processing facilities. The processing devices, or units, or modules, or facilities, may be coupled such that portions of the processing and/or data manipulation may be performed at one or more processing devices, units, modules, facilities and shared or transmitted between a plurality of processing devices.

Thus, an example of the invention is described in a network environment, Specifically, FIG. 1 shows a network environment 100 adapted to support various embodiments of the present invention. The exemplary environment 100 includes a network 104, remote storage modules, or content modules, or facilities or units 160 and 170. (A module, as used herein, is for example, a series of instructions stored on a computer-readable, or an electronic storage medium storing program code, or a memory unit storing instructions that is coupled to an associated dedicated processing unit for execution of the instructions, the module may be a plugin unit, stand alone set of instructions, or program code or may be an integral part of a larger component. Each module may be stored in a separate memory or a common computer memory. The module may also be a non-transitory electronic storage medium, memory register, removable memory (zip drive) or other register or storage repository.) FIG. 1 also shows a plurality of terminals 102(a) . . . 102(n), (where “n” is any suitable number) operatively coupled to a corresponding synthesis device 180(a) . . . (n) (where “n” is any suitable number).

The network 104 is, for example, any combination of linked computers, or processing devices, adapted to transfer and process data. The network 104 may be private Internet Protocol (IP) networks, as well as public IP networks, such as the Internet that can utilize World Wide Web (www) browsing functionality. An example of a wired network is a network that uses communication busses and MODEMS, or DSL lines, or a local area network (LAN) or a wide area network (WAN) to transmit and receive data between terminals. An example of a wireless network is a wireless LAN. Global System for Mobile Communication (GSM) is another example of a wireless network. The GSM network is divided into three major systems which are the switching system, the base station system, and the operation and support system (GSM). Also, IEEE 802.11 (Wi-Fi) is a commonly used wireless network in computer systems, which enables connection to the Internet or other machines that have Wi-Fi functionality. Wi-Fi networks broadcast radio waves that can be picked up by Wi-Fi receivers that are attached to different computers.

Content modules 160 and 170 may be for example a server computer operatively connected to network 104, via bi-directional communication channel, or interconnector 128, 172, respectively, which may be for example a serial bus such as IEEE 1394, or other wire or wireless transmission medium. The terms “operatively connected” and “operatively coupled”, as used herein, mean that the elements so connected or coupled are adapted to transmit and/or receive data, or otherwise communicate. The transmission, reception or communication is between the particular elements, and may or may not include other intermediary elements. This connection/coupling may or may not involve additional transmission media, or components, and may be within a single module or device or between the remote modules or devices.

The content modules 160, 170 are adapted to transmit data to, and receive data from, terminals 102(a) . . . (n) and 160 and 170, via the network 104. The content modules 160, 170 and terminals 102 typically utilize a network service provider, such as an Internet Service Provider (ISP) or Application Service Provider (ASP) (ISP and ASP are not shown) to access resources of the network 104. The content modules 160, 170 may be used to store algorithms, recipe data, chemical formulations, previously executed recipes, and any other data related to the chemical synthesis device 180.

Terminals 102(a) . . . (n) (where “n” is any suitable number) (generally referred to as 102) are coupled to network 104 via an associated bi-directional communication medium 122(a) . . . (n), which may be for example a serial bus such as IEEE 1394, or other wire or wireless transmission medium. Terminals 102 may be communication appliances, or user locations, or subscriber devices, or client terminals. For example, terminals 102 may be computers, or other processing devices such as wireless handheld device, a desktop computer, laptop computer, personal digital assistant (PDA), any processing device with adequate storage and processing capabilities. They may be capable of processing and storing data themselves or merely capable of accessing processed and stored data from another location (i.e., both thin and fat terminals).

Synthesis devices 180(a) . . . (n) (generally referred to as 180 herein) are typically apparatus used to perform synthesis of chemical compounds, such as F-18, radiopharmaceuticals and other formulations. Each device is typically coupled to a processing module 102 via a bi-directional communication medium (182), which may be for example), which may be for example a serial bus such as IEEE 1394, or other wire or wireless transmission medium.

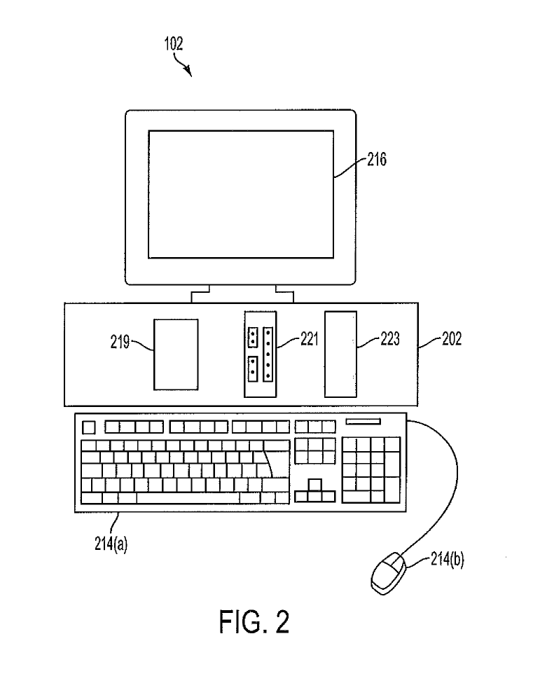

FIG. 2 illustrates an example of a processing apparatus, or terminal 102 according to an embodiment of the present invention. Terminals 102 typically include a display unit 216, processor module 202 and an input units 214(a) (keyboard) and 214(b) (mouse).

The display unit 216 is used to display the data generated and/or accessed by the terminal 102 and/or system (shown in FIG. 1, as element 100) as well as input generated at the terminal 102, and the content generated by content modules (shown in FIG. 1, as elements 160, 170). The display unit 216 of terminal 102 may be, for example, a monitor, LCD (liquid crystal display), a plasma screen, a graphical user interface (GUI), touch screen, or other unit adapted to display output data typically by a representation of pixels to form text and graphic and video data.

Processor module 202 typically includes a CPU and ALU unit as well as various drives and input ports (e.g., 219, 21, 223). Processor module 202 may be substantially any multi-purpose processor with sufficient processing speed and functionality to perform the requisite data processing. Processor module 202 also typically includes memory, or storage media to store data that is processed as well as operating systems and other programs.

The input unit (generally 214) may include devices such as a keyboard, mouse, track ball and/or touch pad or any combination thereof.

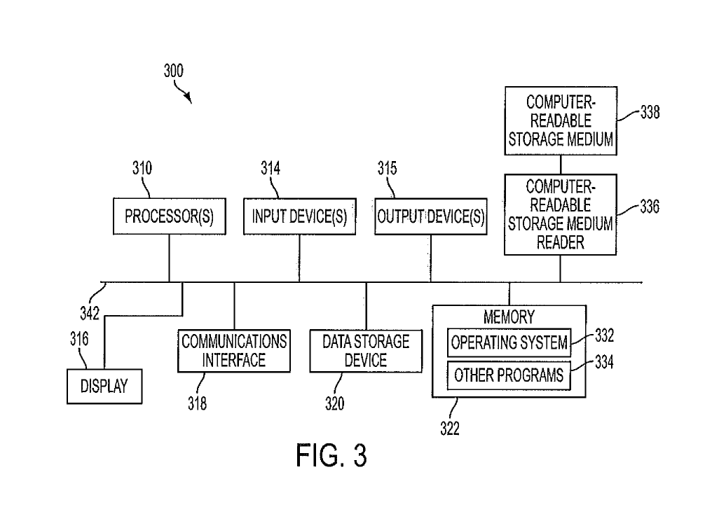

FIG. 3 shows an example of a processor module 300, which may be used in a similar fashion as terminal 102, as described herein. For example, processor 300 may be coupled to the network 104 and synthesis device 180, shown in FIG. 1. Processor module 300 includes one or more processors 310, input device(s) 314, output device(s) 315, display unit 316, communication interface 318, data storage device 320, memory module 322, computer readable storage medium reader 336, computer readable storage medium 338 and bus 342.

As shown in FIG. 3, processor module 300 includes one or more processors 310, which is typically a CPU or other processor that includes an arithmetic logic unit (ALU), which performs arithmetic and logical operations, and a control unit (CU), which extracts instructions from memory and decodes and executes them, utilizing the ALU when necessary.

Processor module 300 also includes input devices 314, which may include a keyboard, touch screen, track ball, mouse, GUI, scanner, or other mechanism that permits a user to input data or permit the processor to access data.

Output devices 315 typically include speakers, ports, printers, and other modules and mechanisms to enable the processor 300 to provide output from the processor 300. Display device 316 is another example or an output module or unit. The display unit 316 may be similar to the display unit 216 described in relation to FIG. 2, which may be, for example, a monitor, LCD (liquid crystal display), a plasma screen, a graphical user interface (GUI), touch screen, or other unit adapted to display output data typically by a representation of pixels to form text and graphic and video data.

A communications interface 318 may be used to operatively couple the components of processor module 300 to other elements, or modules, as shown in FIG. 1.

Data storage device 320 is used to store data related to the operation and functionality of processor unit 300.

Memory module 322 includes operating storage module 332 and other program storage module 334. These storage modules 322, 332, 334 store programs, which include, for example, a web browser, algorithms, as well as typical operating system programs (not shown), input/output (I/O) programs (not shown), BIOS programs (not shown) and other programs that facilitate operation of processor module 300. The web browser (not shown) is for example an Internet browser program such as Internet Explorer™. Memory module 322 may be, for example, an electronic storage medium, such as an electronic storage repository that can store data used by processor module 300 or other facility in network 100 of FIG. 1. The memory module 322 may include, for example, RAM, ROM, EEPROM or other memory media, such as an optical disk, optical tape, CD, or a floppy disk, a hard disk, or a removable cartridge, on which digital information is stored in the form of bits. The memory module 322 may also be remote memory coupled to processing module 300 via wired or wireless bi-directional communication medium.

Computer readable storage medium reader 336 and computer readable storage medium 338 are computer readable electronic storage media used for reading and storing data, which includes memory or storage locations, which are used to store generation algorithms and/or generation program code that may be stored on an electronic and/or computer-readable medium and executed by one or more processors to generate a content, such as recipe execution, according to embodiments of the present invention and/or generate a display.

Bus 342 is used to provide a communication medium for processor unit 300 to/with other modules, as described herein.

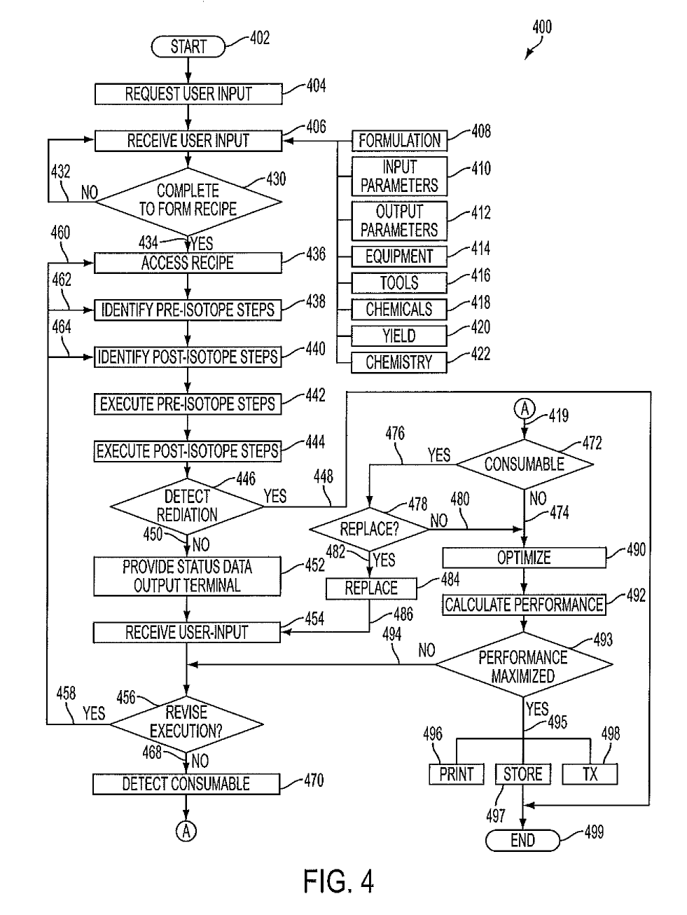

FIG. 4 shows an example 400 of a series of steps, or algorithm, or steps that may be written as program code (source code), or steps that have been compiled (object code) or a combination thereof that may be executed. The steps may be stored in a recorded medium, such as a non-transitory computer readable medium, in a local or remote storage location or accessed via a network. The graphical user interface (GUI) of the present invention controls all systems and subsystems in a seamless manner. For example, the GUI controls the systems and subsystems that follow synthesis of a compound. These subsystems include, for example, purification (HPLC or SPE-based) and reformulation.

The series of steps 400 begins with start step 402. User input is requested, as shown by step 404. This user input may include, for example, what chemical is to be synthesized, what chemicals are available, has the recipe been executed previously and other information. The user input is received, as shown in step 406. The input may be received via a keyboard or other input module and/or accessed from a storage location, which may be local or remote. Examples of received user input include: formulation data 408; input parameters 410; output parameters 412; equipment 414; tools 416; chemicals 418; yield 420; and chemistry 422.

A determination is made whether the input received and/or accessed is sufficient to form a recipe, as shown in step 430. If not, “no” line 432 shows that input reception step 408 is reached. If the received/accessed input is sufficient to form a recipe, “yes” line 434 shows that a recipe is accessed, as shown in step 436. This recipe may be accessed from a memory or storage location or from user input.

An identification of pre-isotope steps is made, as shown in step 438 and an identification of post-isotope steps is made, as shown in step 440. Execution of pre-isotope steps and post-isotope steps is performed, as shown in steps 442 and 444, respectively.

A radiation detection step is shown (446) which detects whether any radiation is present. If radiation is detected; “yes” line 448 leads to end step 499 since the radiation is typically remediated before the recipe is executed.

If radiation is not detected; “no” line 450 shows that status data of the output terminal is provided as shown in step 452. Additional user input may then be received, as shown in step 454. A determination is made whether execution should be revised, as shown in step 456. If so; “yes” line 458 leads to access recipe (436) via line 460; and/or identify pre-isotope steps (438) via line 462; and/or identify post-isotope steps (440) via line 464.

If execution should not be revised; “no” line 468 shows that consumables are detected, as shown in step 470. A determination of what consumables have been used is made in step 472. If consumables are used, “yes” line 476 shows that a determination is made if the consumable should be replaced, as shown in step 478. If so; “yes line 482 shows that the consumable is replaced, as shown in step 484. Line 486 shows that user input step 454 is reached. If the consumable does not need to be replaced (478); “no” line 480 shows that optimization step 490 is reached. This optimization step 490, may also be reached by “no” line 474 from step 472. Optimization step 490 provides an opportunity to optimize the recipe by reducing redundant steps and maximizing efficiency of use of components. The performance may be calculated, as shown in step 492. This performance calculation may be a quantitative rating, or value, of the recipe execution. This value may be obtained by an algorithm. In step 493 a determination is made whether the performance is maximized. If the performance is not maximized; “no” line 494 shows the execution may be revised, as shown in step 458.

If the performance is maximized; “yes” line 495 shows the results of the recipe, such as formulation and other data may be printed (496) and/or stored (497) and/or transmitted (498). The algorithm ends, as shown in step 499. Also, the synthesis device (FIG. 1, device 180) may output the actual chemical compound.

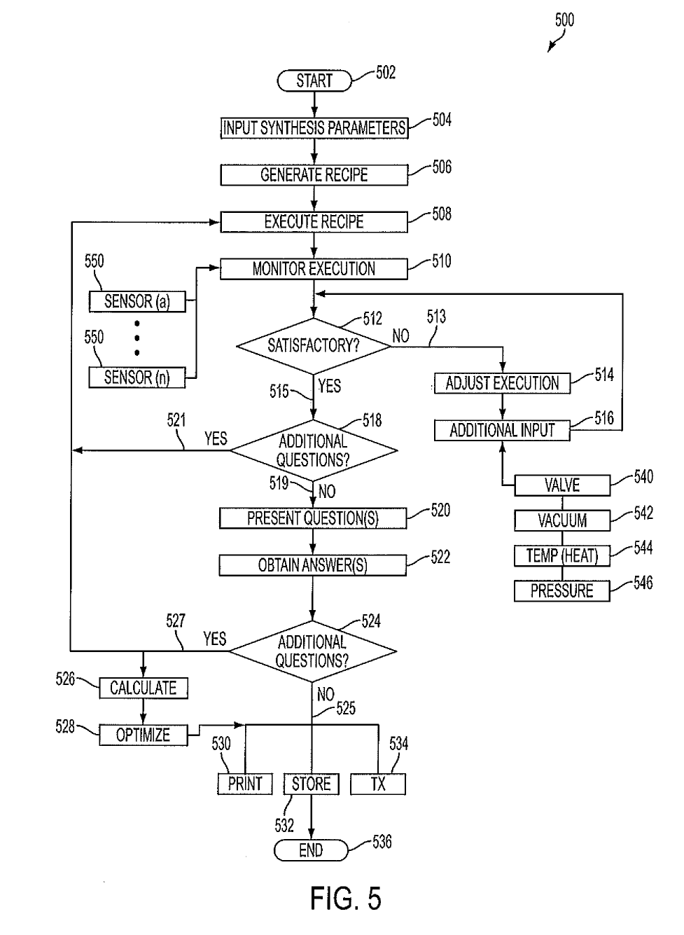

FIG. 5 shows another example of an algorithm 500 according to an embodiment of the present invention. The algorithm 500 may be for example a series of steps, or algorithm, or steps that may be written as program code (source code), or steps that have been compiled (object code) or a combination thereof that may be executed. The steps may be stored in a recorded medium, such as a non-transitory computer readable medium, in a local or remote storage location or accessed via a network.

The series of steps 500 begins with start step 502. Synthesis parameters are input, as shown in step 504. These input parameters include a desired chemical compound, a formulation, chemicals and other pertinent information. A recipe is generated, as shown in step 506. The recipe is executed, as shown in step 508. Execution of the recipe is monitored, as shown in step 510. This monitoring may include alert signals or indicators. Sensor output 550(a) . . . (n) (where “n” is any suitable number) may be used during monitoring the execution of the recipe.

A determination is made whether the execution is satisfactory, as shown in step 512. If the execution is not satisfactory; “no” line 513 shows that execution is adjusted, as shown in step 514. The adjustment of step 514 may be the result of additional input, as shown in step 516. This additional input may include modifications of components, such as, for example: valves (540); vacuum (542); temperature, such as heat (544) and pressure (546).

If the execution is satisfactory, “yes” line 515 leads to a determination of whether there are additional questions are needed. If so; “yes” line 521 execution step 508 is reached. If no additional questions are needed, “no” line 519 shows that question(s) presented step 520 is reached. These questions are relevant to the recipe being executed. Answers to the questions are obtained as shown in step 522. These answers are typically received from a user, technician or operator. A determination is made whether there are additional questions, as shown in step 524. If yes, “yes” line 527 shows that execution step 508 is reached. If there are no additional questions, “no” line 525 shows that the results of the recipe, such as formulation and other data may be printed (530) and/or stored (532) and/or transmitted (534). The algorithm ends, as shown in step 536. Also, the synthesis device (FIG. 1, device 180) may output the actual chemical compound.

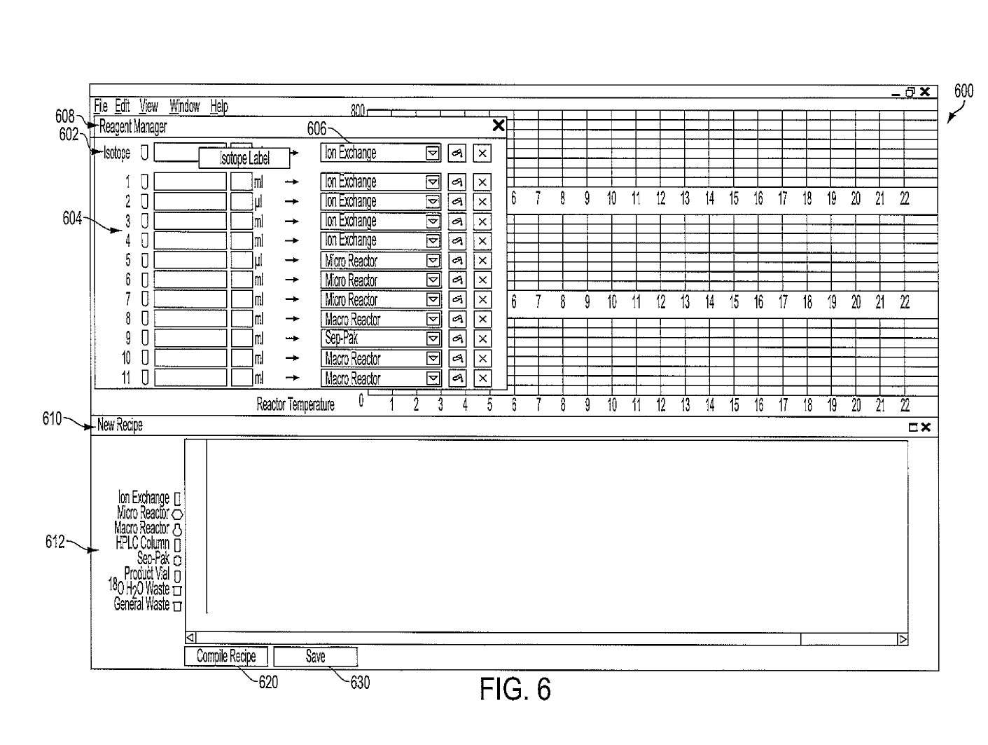

FIG. 6 shows a screen shot 600 that includes reagent manager portion 608 and new recipe portion 610.

Reagent manager 608 includes isotope field 602, entry field 604, and element field 606. Isotope field 602 provides for an isotope, such as F-18. Entry field 604 provides for entry of a compound, such as K222. Element field 606 may be used for a component, such as ion exchange.

New recipe portion 610 includes element or component listing 612. This listing 612 may include ion exchange, micro reactor, macro reactor, HPLC column, Sep-Pak, product vial, specific waste and general waste.

Also shown in FIG. 6 are compile recipe command 620 and save command 630.

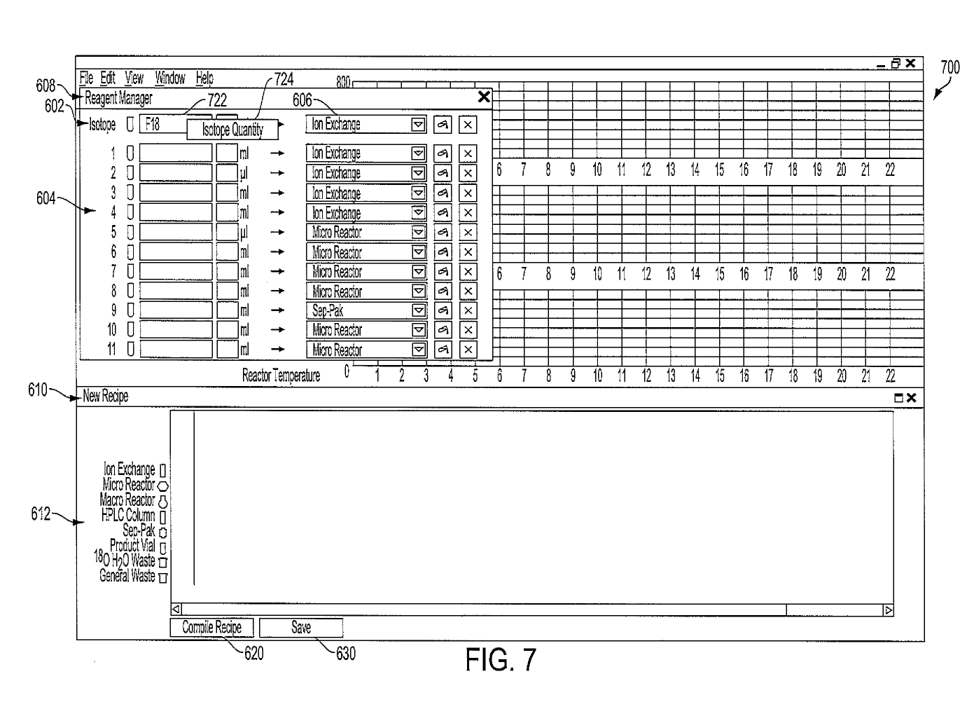

FIG. 7 shows another screen shot that includes F-18 isotope (722) in isotope field 602. Isotope quantity field 724 is also shown. The other elements have been discussed previously.

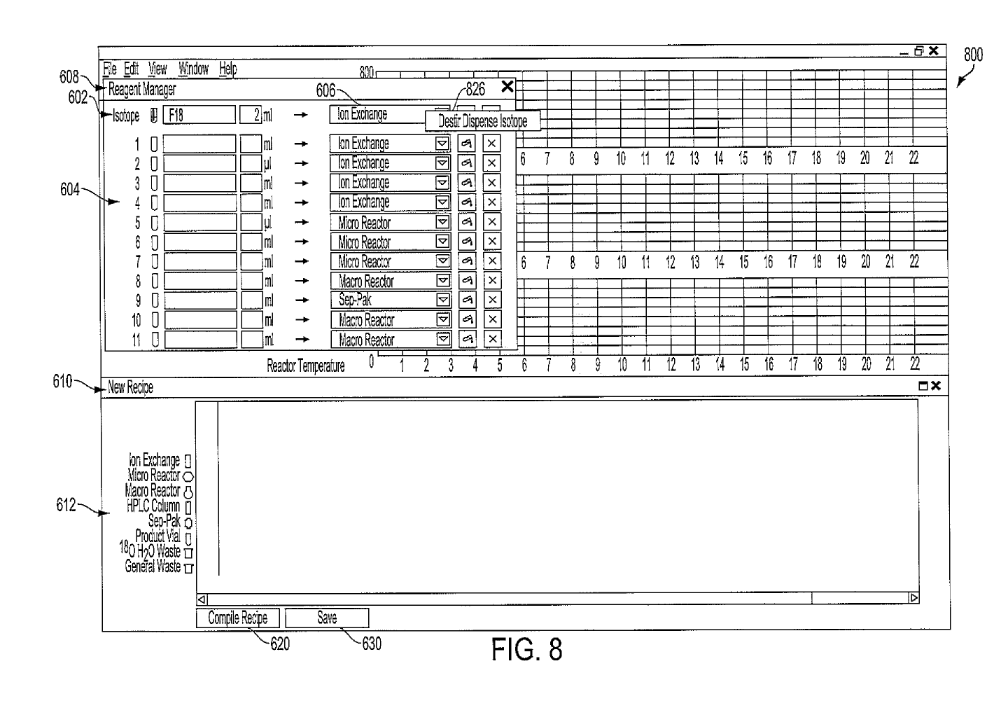

FIG. 8 shows another screen shot that includes Ion Exchange in field 606 and “Destir Dispense Isotope” 826. The other elements have been discussed previously.

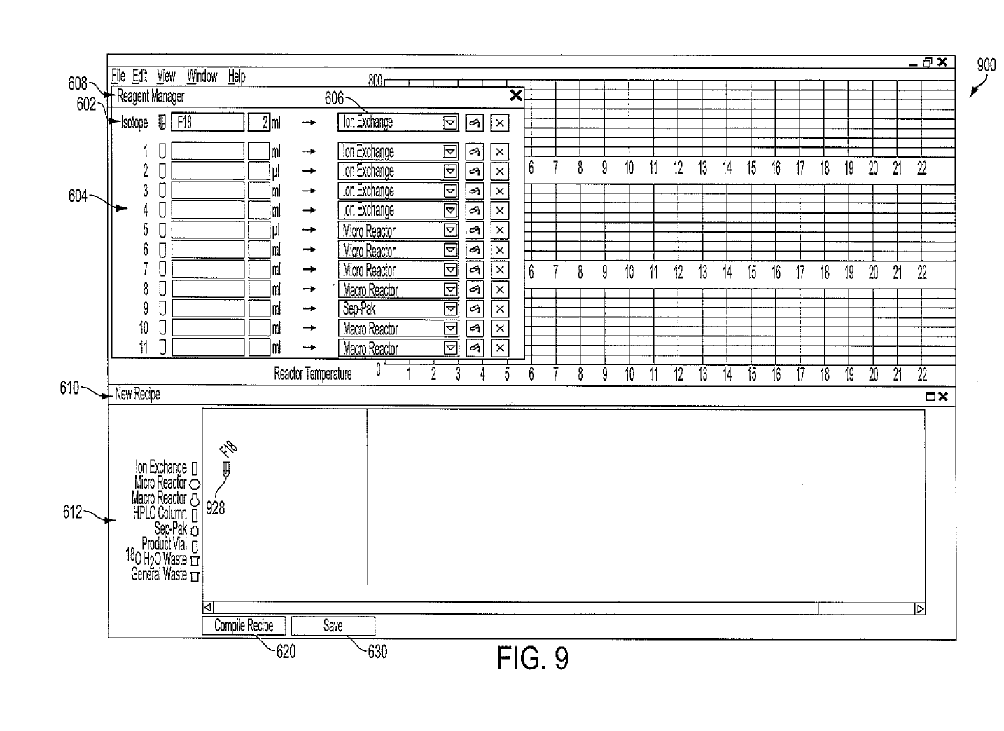

FIG. 9 shows another screen shot that includes F-18 (928) in “New Recipe” section 610. This F-18 indicator shows that a recipe for F-18 is to be executed. The other elements of FIG. 9 have been discussed previously.

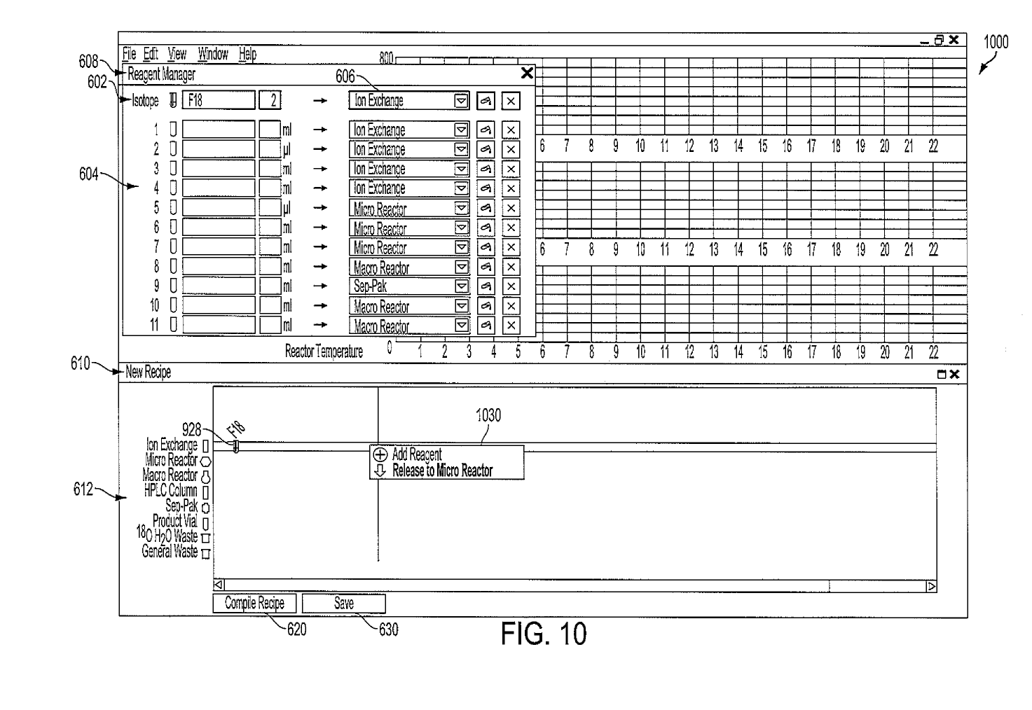

FIG. 10 shows another screen shot that includes a menu screen 1030 that permits addition of reagent and release to Micro Reactor. The other elements of FIG. 10 have been discussed previously.

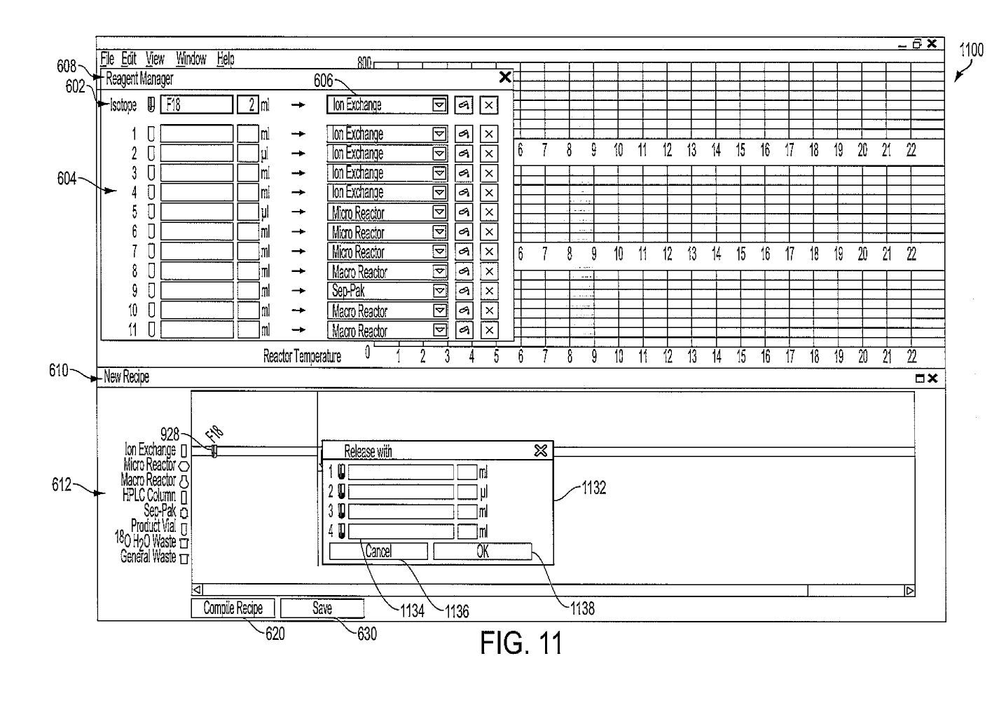

FIG. 11 shows another screen shot that includes a menu screen 1132. The menu screen 1132 shows that a chemical may be released during the execution of the recipe. Menu 1132 has four rows “1”, “2”, “3” and “4” 1134 that permits identification of chemicals and a volume. “Cancel” button 1136 and “OK” button 1138 are shown. The other elements of FIG. 11 have been discussed previously.

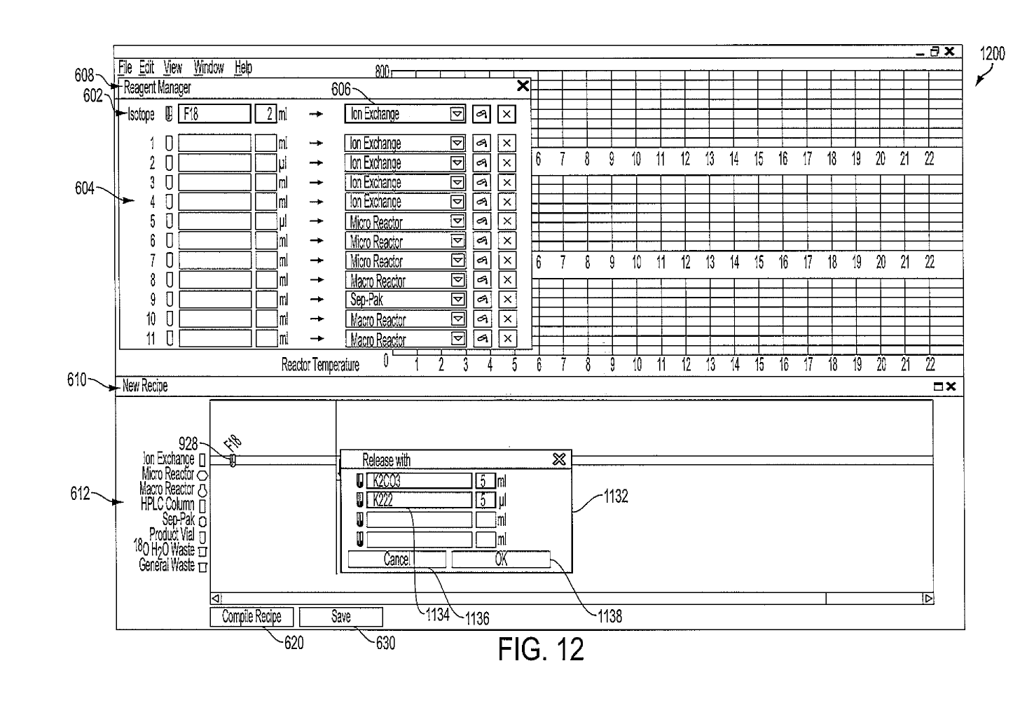

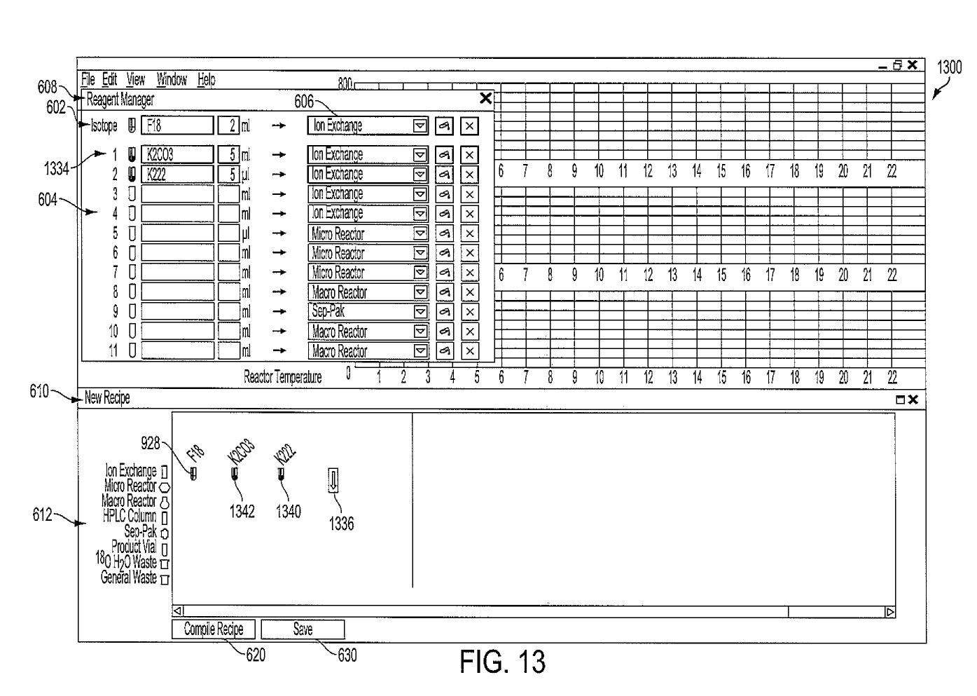

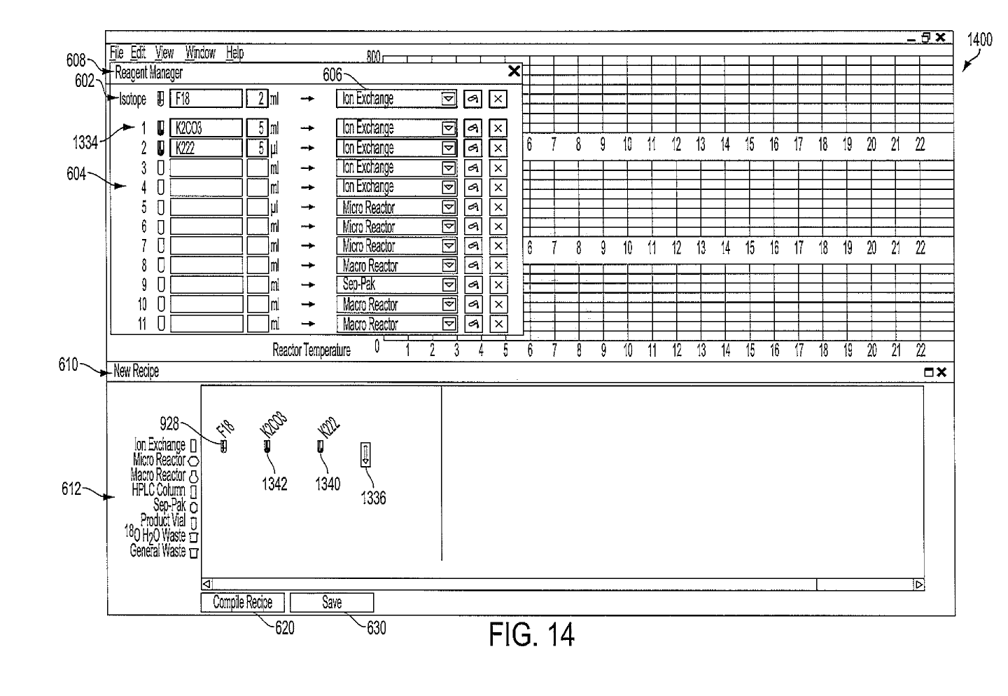

FIG. 12 shows another screen shot that includes some (two) of the fields 1134 of menu screen 1132 filled in. Specifically, two rows of menu fields 1134 are: 1. K2CO3 of 5 ml; and 2. K222 of 5 ml are released. Rows “3” and “4” do not have any input. The other elements of FIG. 12 have been discussed previously.

FIGS. 13 and 14 show other screen shots that include an indication in reagent manager 608 that: 1. K2CO3 of 5 ml in ion exchange; and 2. K222 of 5 ml in ion exchange as shown by element 1334. New Recipe portion 610 has a representation of an action 1336; a representation that K222 has been introduced 1340, a representation that K2CO3 has been introduced 1342. These occur in the ion exchange. The other elements of FIG. 13 have been discussed previously.

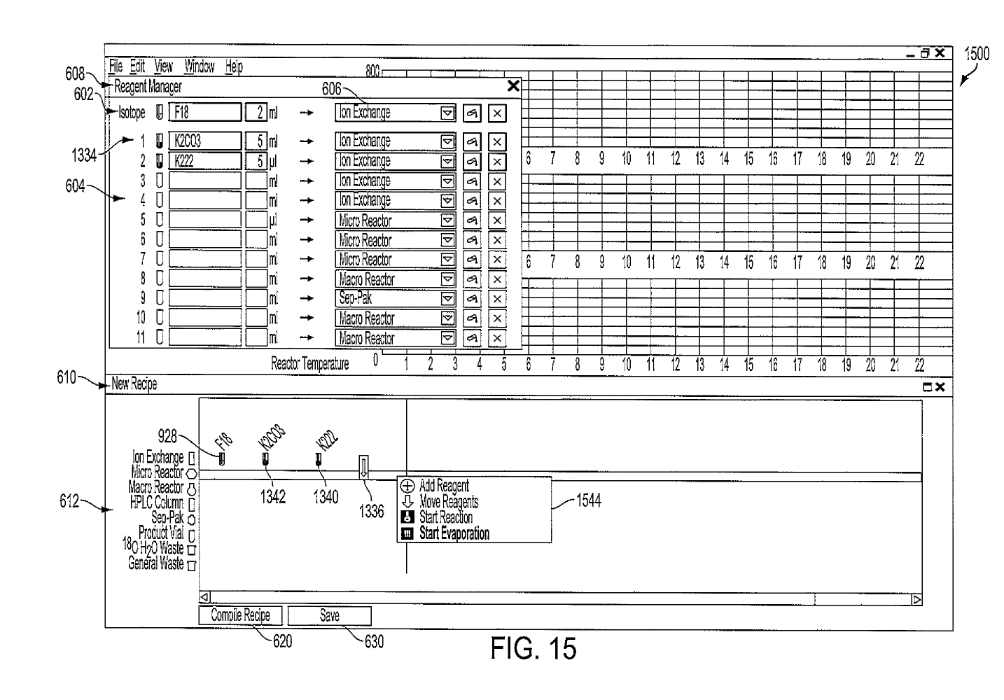

FIG. 15 shows another screen shot that shows that in New Recipe portion 610, display area 1544 shows steps: add reagent; move reagents; start reaction; and start evaporation. The other elements of FIG. 15 have been discussed previously.

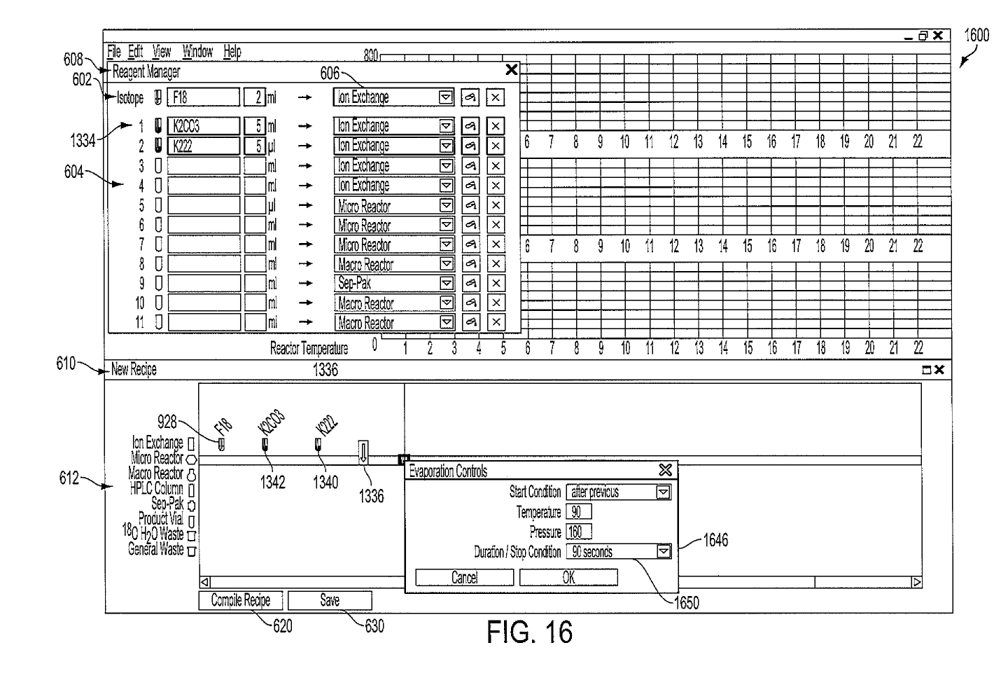

FIG. 16 shows another screen shot that includes a representation of “Evaporation Controls” 1646, which was an item of FIG. 15, element 1544. Evaporation control menu 1646 includes fields 1650, which include: start condition; temperature; pressure; and duration/stop condition. The other elements of FIG. 16 have been discussed previously.

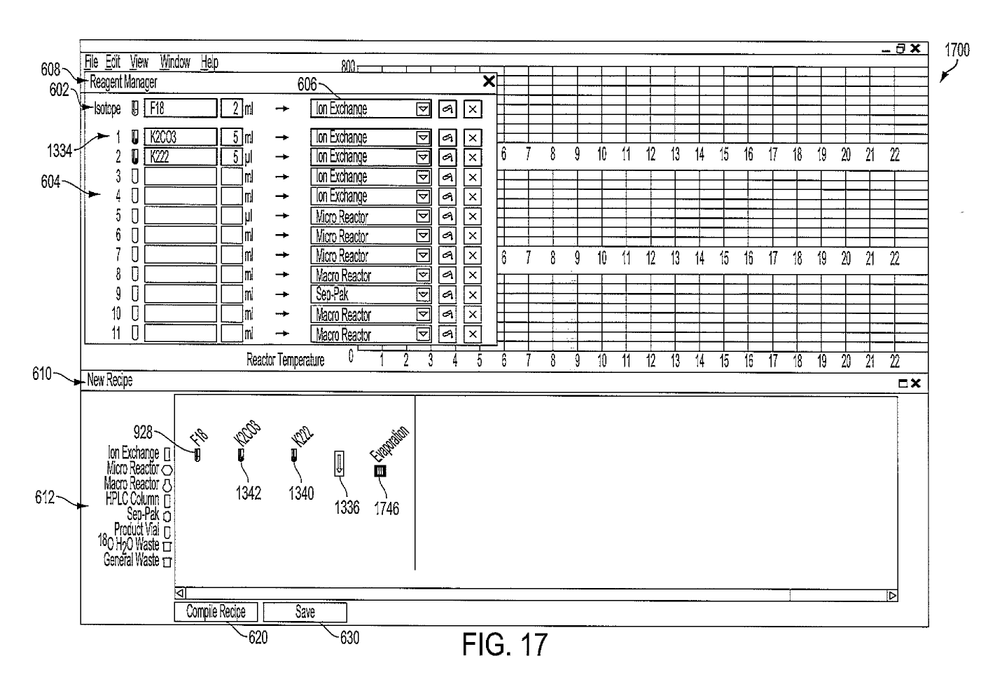

FIG. 17 shows that the previously opened evaporation control menu is represented as an indicator 1746 and is in the “Micro Reactor” row of New recipe portion 610. The other elements of FIG. 17 have been discussed previously.

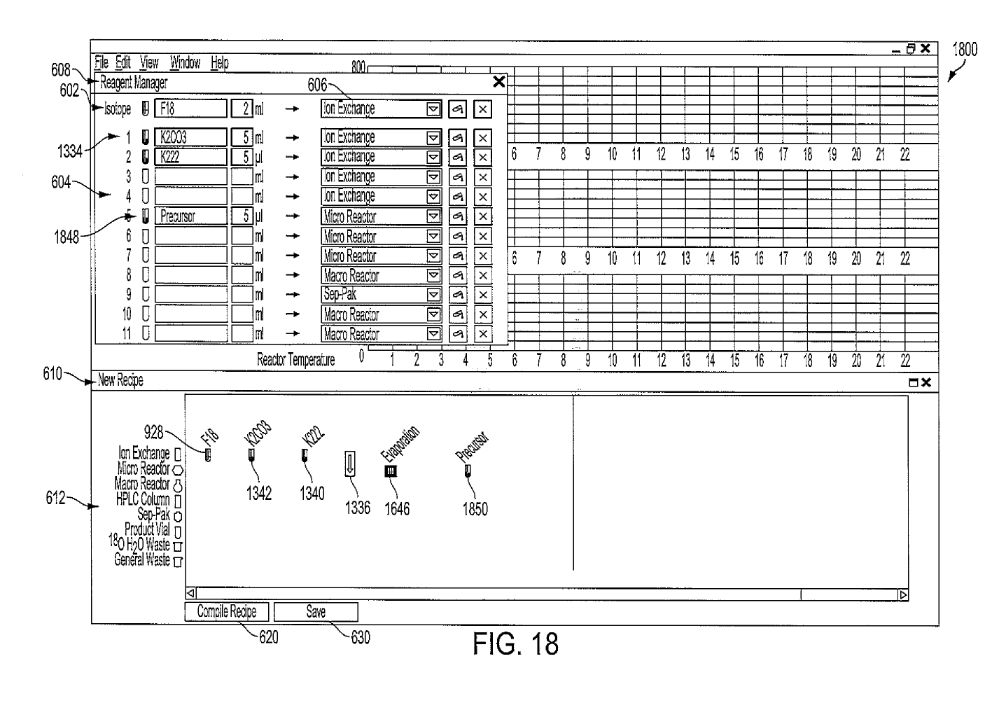

FIG. 18 shows another screen shot that includes a representation of a precursor 1850 in the Micro Reactor row of New Recipe portion 610. Also, Precursor in row 5 and “Micro-Reactor” 1848 of steps 604 of Reagent Manager portion 608 are shown. The other elements of FIG. 18 have been discussed previously.

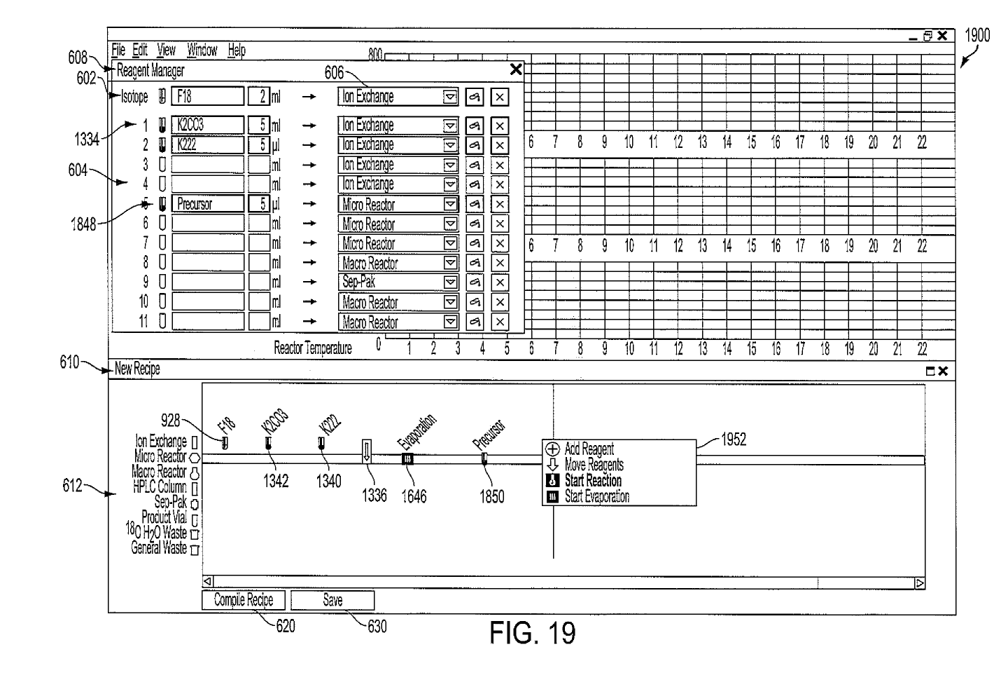

FIG. 19 shows another screen shot that shows that New Recipe portion 610 includes display area 1952 that shows steps: add reagent; move reagents; start reaction; and start evaporation. The other elements of FIG. 19 have been discussed previously.

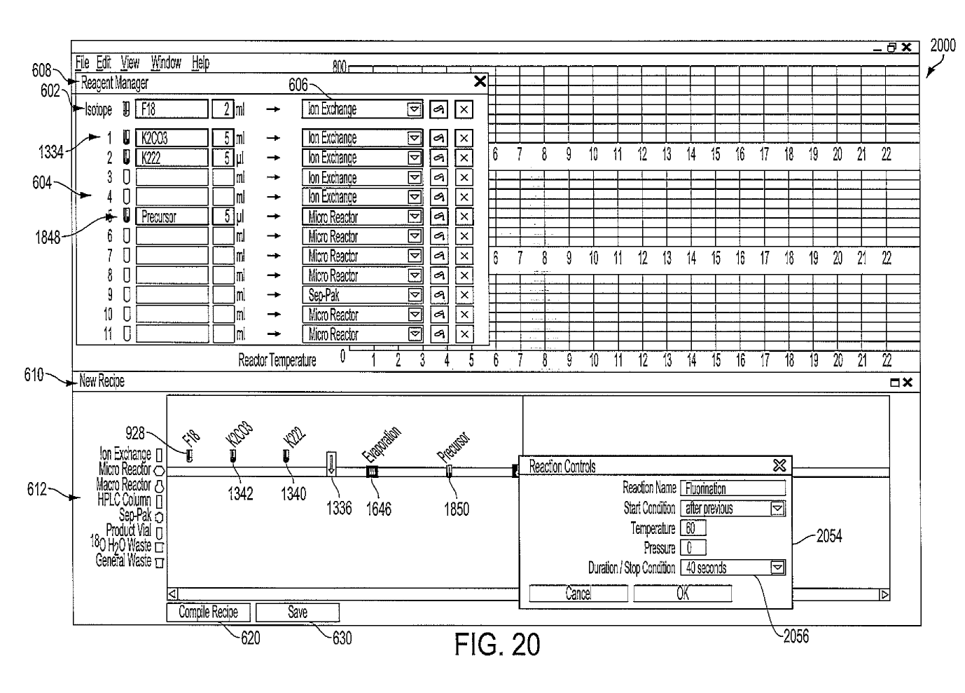

FIG. 20 shows another screen shot that includes a representation of “Reaction Controls” 2054. Reaction control menu 2054 includes fields 2056, which include: reaction name; start condition; temperature; pressure; and duration/stop condition. The other elements of FIG. 20 have been discussed previously.

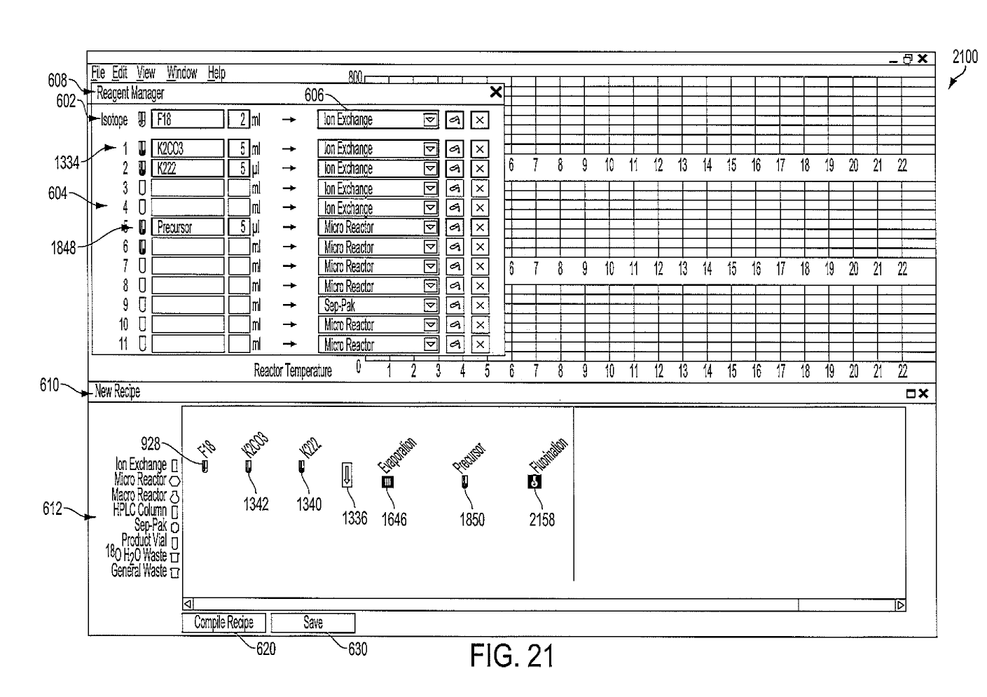

FIG. 21 shows another screen shot that shows that the previously opened fluorination control menu is represented as an indicator 2158 and is in the “Micro Reactor” row of New recipe portion 610. The other elements of FIG. 21 have been discussed previously.

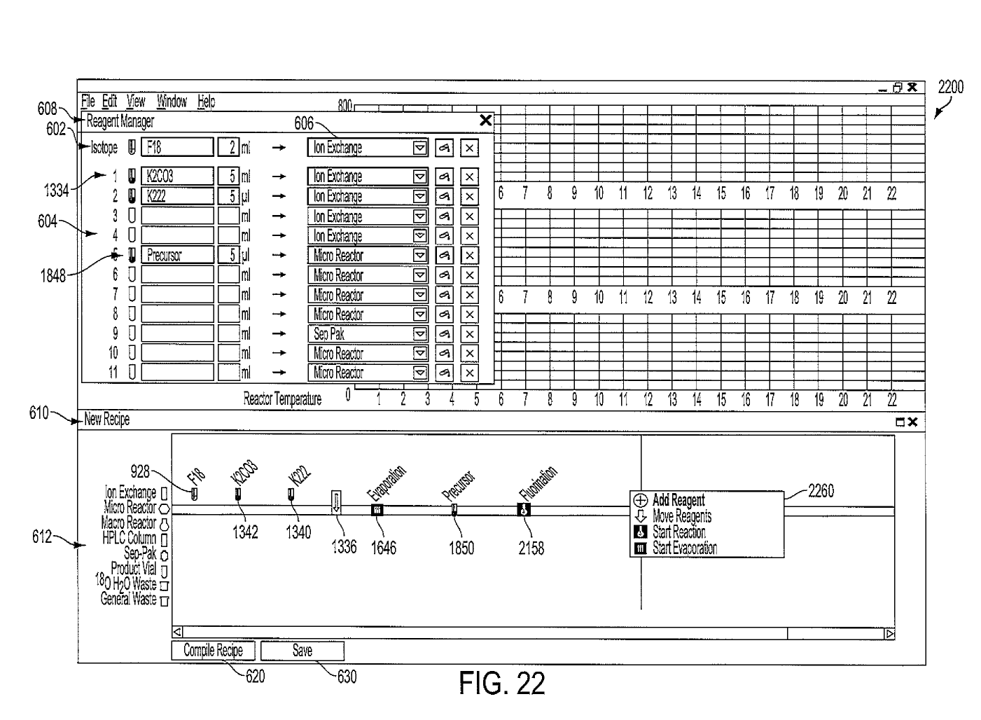

FIG. 22 shows another screen shot that shows that in New Recipe portion 610, display area 2260 shows steps: add reagent; move reagents; start reaction; and start evaporation. The other elements of FIG. 22 have been discussed previously.

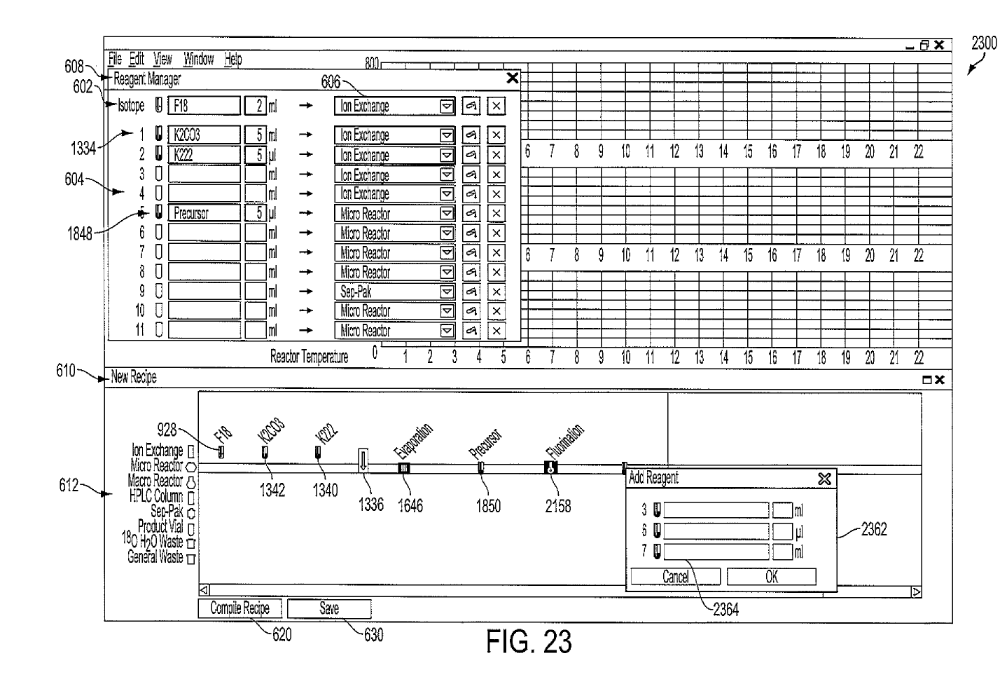

FIG. 23 shows another screen shot that includes a representation of “Add Reagent” 2362 having fields 2364, which include data fields for three reagent names and corresponding volumes. The other elements of FIG. 23 have been discussed previously.

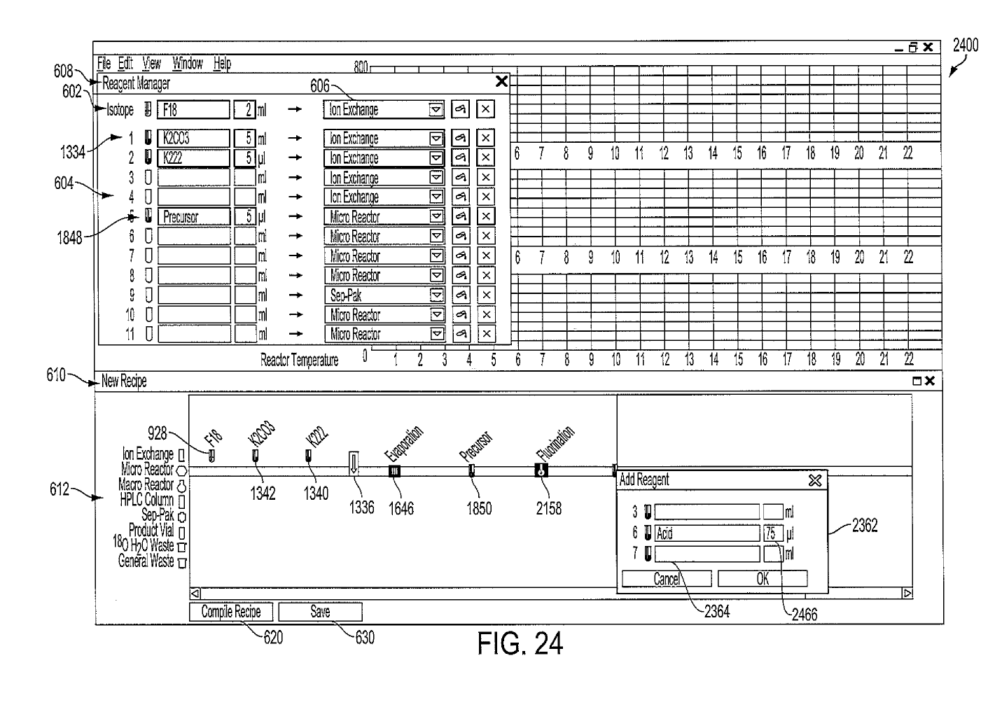

FIG. 24 shows another screen shot that includes “Acid” of 75 ml in filed number 6, shown as element 2466. The other elements of FIG. 24 have been discussed previously.

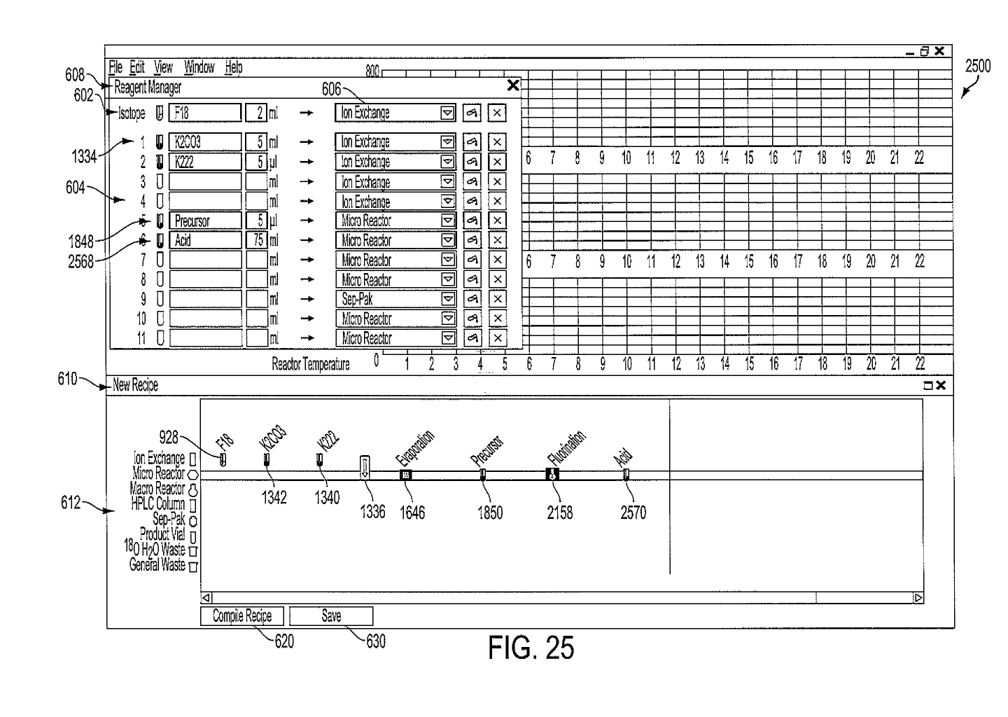

FIG. 25 shows another screen shot that includes a representation of a precursor acid 2570 in the Micro Reactor row of New Recipe portion 610. Also, Acid in row 6 and “Micro-Reactor” 2568 of steps 604 of Reagent Manager portion 608 are shown. The other elements of FIG. 25 have been discussed previously.

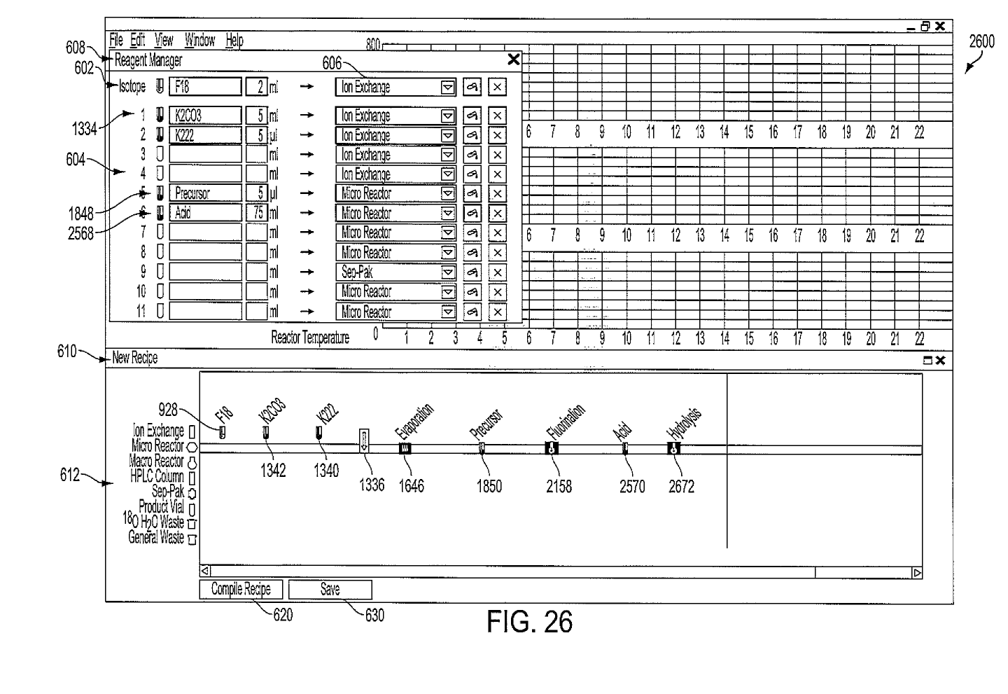

FIG. 26 shows another screen shot that includes an indicator of “hydrolysis” 2672 is in the “Micro Reactor” row of New recipe portion 610. The other elements of FIG. 26 have been discussed previously.

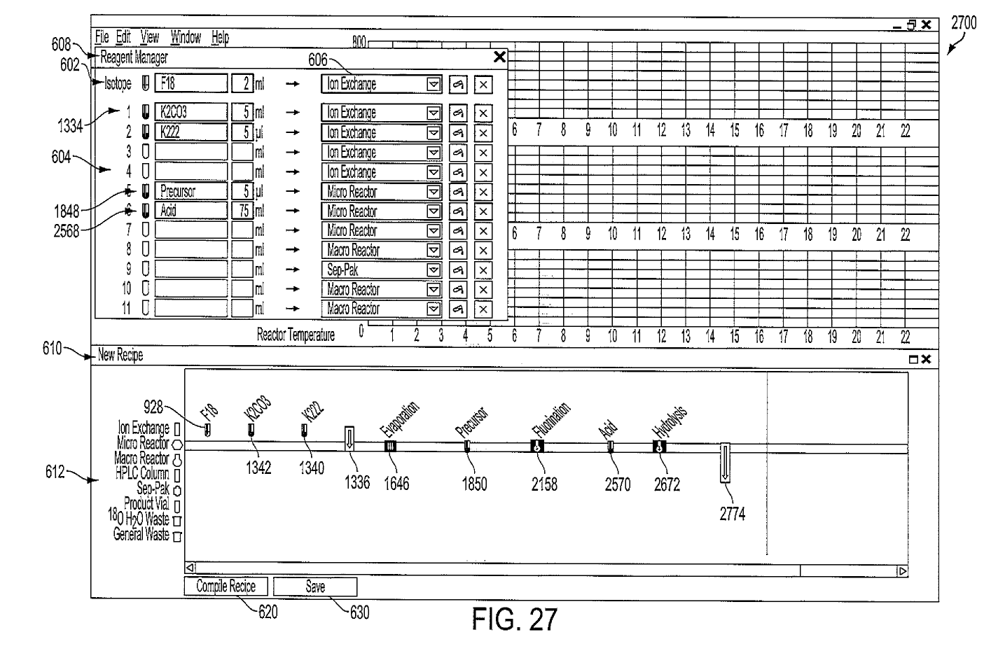

FIG. 27 shows another screen shot that includes an indicator 2774 showing the recipe is moving from the micro reactor to the macro reactor. The other elements of FIG. 27 have been discussed previously.

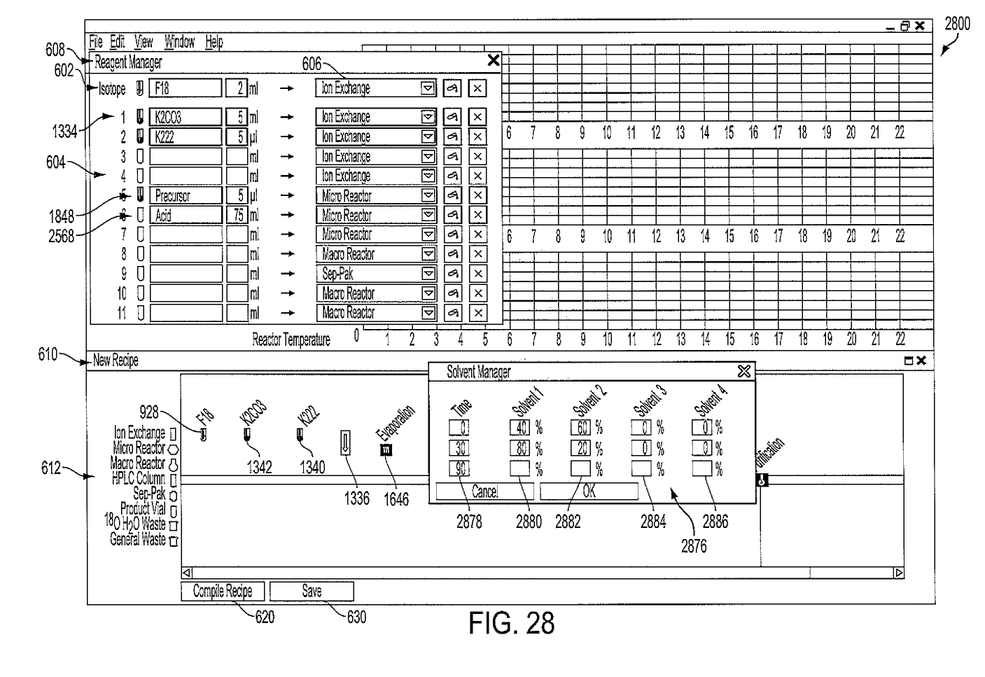

FIG. 28 shows another screen shot that includes a representation, shown as a menu 2876 for “Solvent Manager”. The menu 2876 has a field 2878 for time, which permits a user to input a plurality of desired time intervals. A field “Solvent 1” 2880 shows a concentration for a first solvent. A field “Solvent 2” 2882 shows a concentration for a second solvent. A field “Solvent 3” 2884 shows a concentration for a third solvent. A field “Solvent 4” 2886 shows a concentration for a fourth solvent. The other elements of FIG. 28 have been discussed previously.

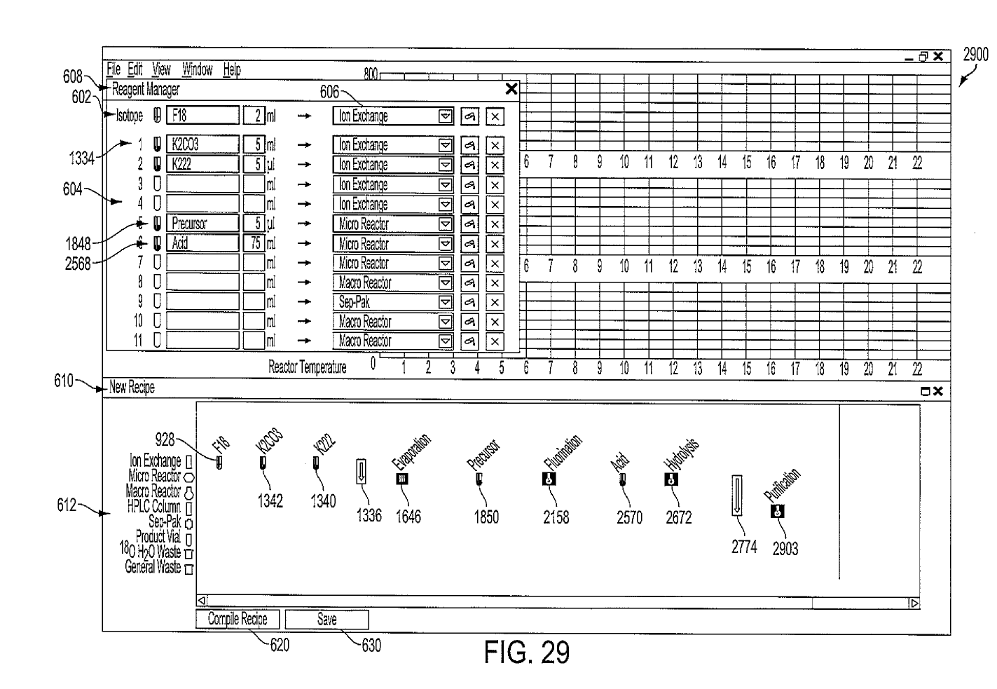

FIG. 29 shows another screen shot that includes an indicator of “purification” 2903 is in the “HPLC Column” row of New recipe portion 610. The other elements of FIG. 29 have been discussed previously.

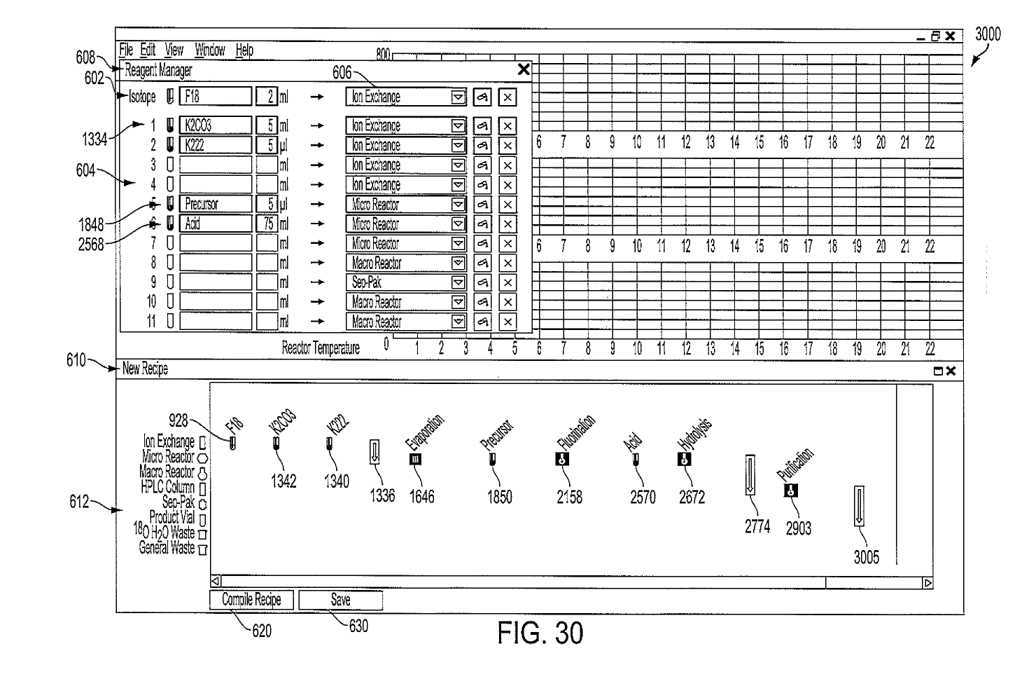

FIG. 30 shows another screen shot that includes an indicator 3005 showing the recipe is moving from the HPLC Column to Product Vial. The other elements of FIG. 30 have been discussed previously.

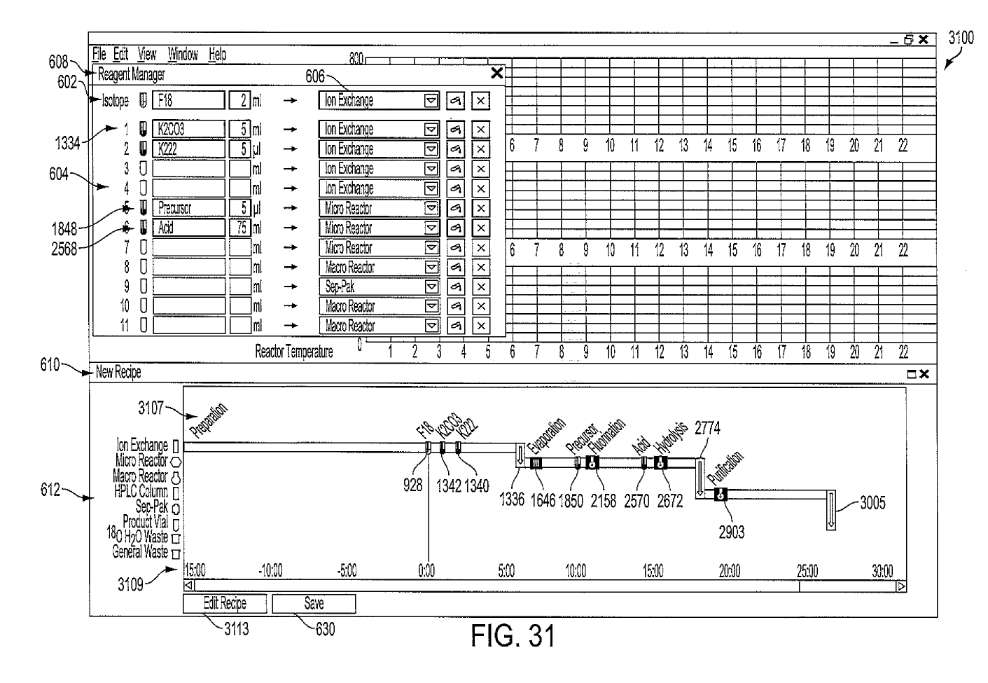

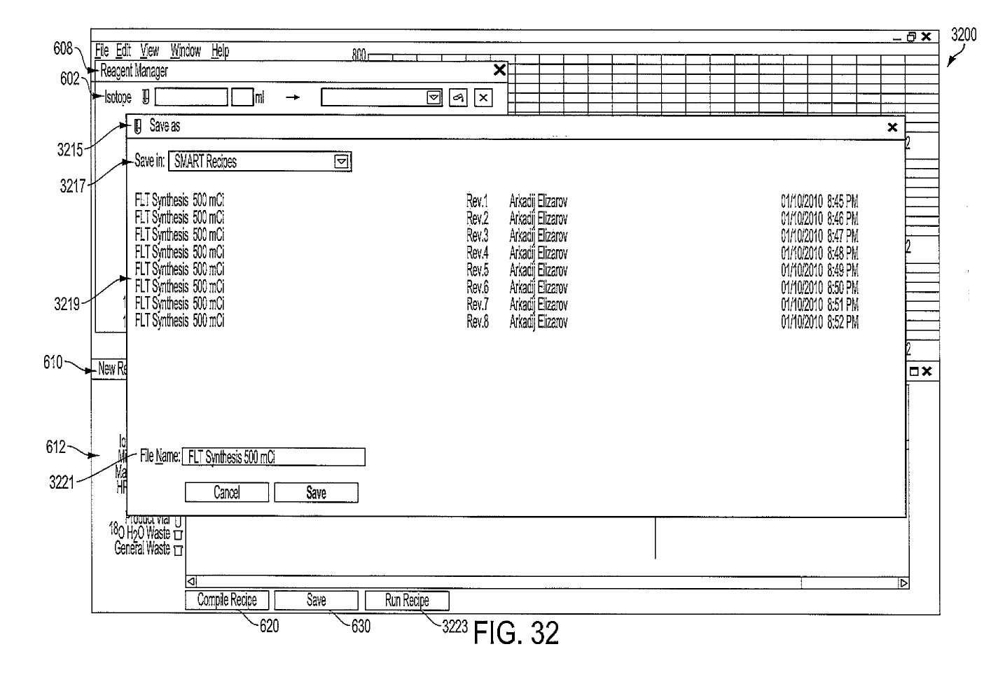

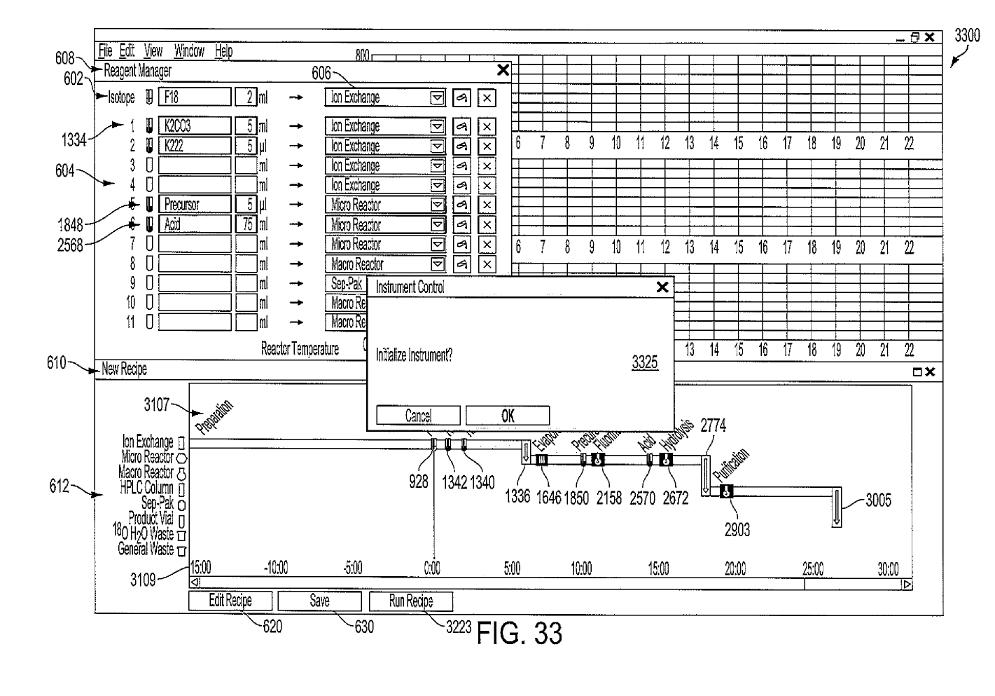

FIG. 31 shows another screen shot that includes a time indication 3109 near the lower portion of New Recipe portion 610. This time indicator 3109 may be used for identifying the time interval between various segments of the execution of the recipe. Also, “edit recipe” menu button 3113 is shown, which permits a user to revise or edit the recipe execution. The other elements of FIG. 31 have been discussed previously.

FIG. 32 shows another screen shot that includes a “save as” menu 3215 super-imposed on the previous menu. The save as menu 3215 has a “save in” portion 3217 that permits storing of a recipe, or portion of a recipe. Various revisions can be tracked by date, time, operator and other criteria, as shown by portion 3219. File name portion 3221 and run recipe portion 3223 are also shown. The other elements of FIG. 32 have been discussed previously.

FIG. 33 shows another screen shot that includes an instrument control panel 3325 super-imposed on the other portions. The instrument control panel 3325 permits a user/operator to initialize the instrument. The other elements of FIG. 33 have been discussed previously.

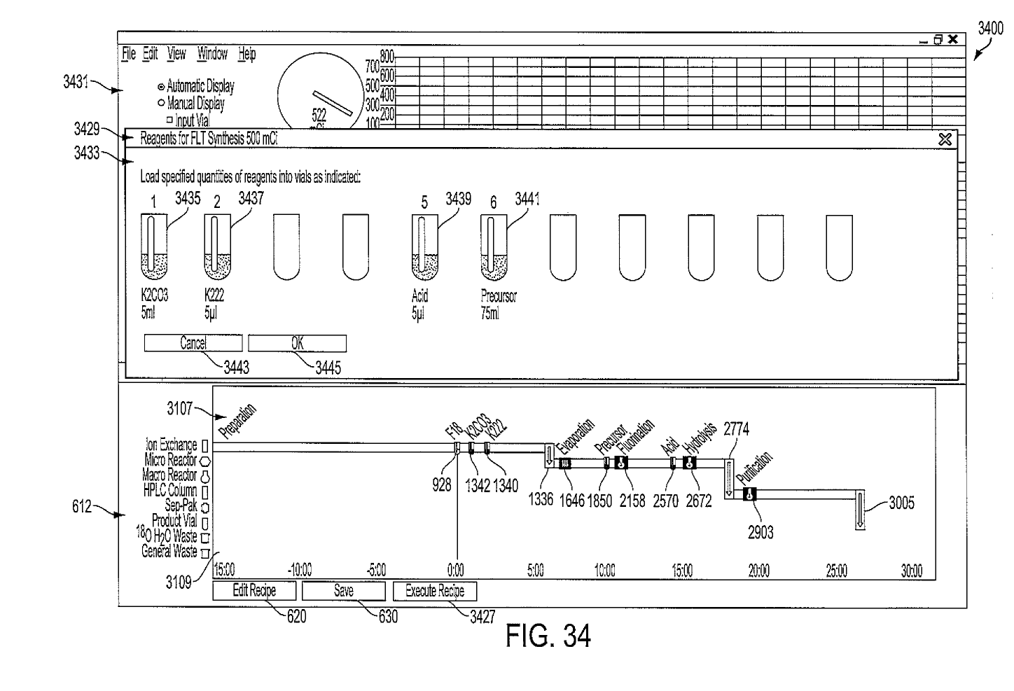

FIG. 34 shows another screen shot that includes reagents for FLT synthesis 500 mCi 3429. This is super-imposed on screen portion 3431. Reagents for FLT synthesis 500 mCi 3429 includes load specified quantities of reagents into vials portion 3433, which includes vial 1 of K2CO3 5 ml (3435), vial 2 of K222 5 μl (3437), vial 5 of acid 5 μl (3439) and vial 6 of precursor 75 ml (3441). “cancel” button 3443; “OK” menu button 3445; and “execute recipe” button 3427 are also shown. The other elements of FIG. 34 have been discussed previously.

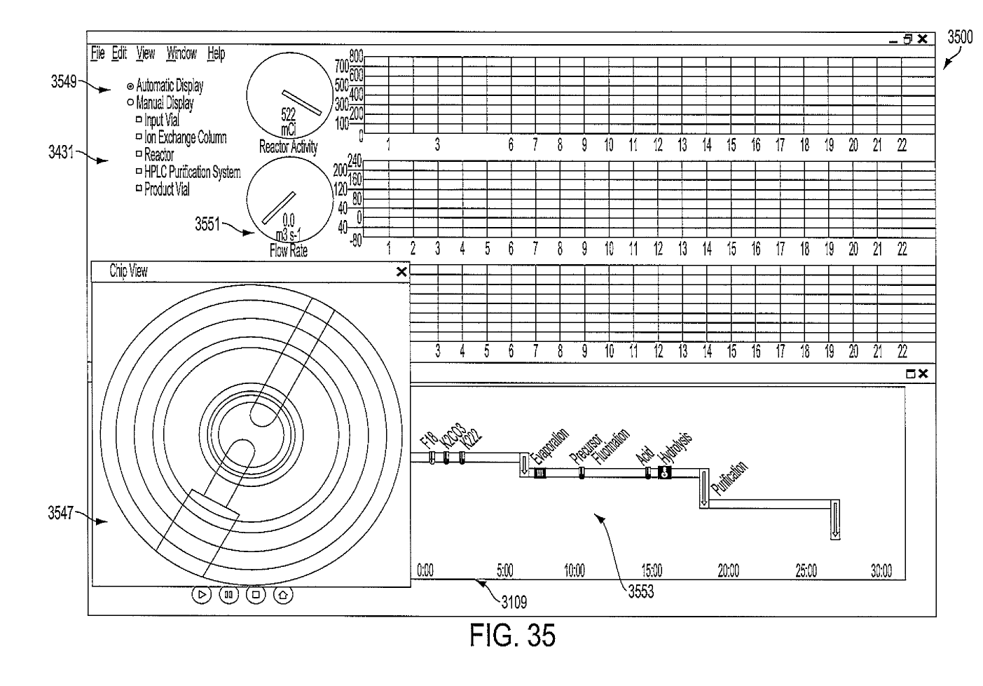

FIG. 35 shows another screen shot that includes a graphic representation of reactor activity 3549 and a graphic representation of flow rate 3551. A chip view 3547 is also shown as well as a status of the reaction, or recipe execution 3553. The chip view 3547 shows an image of the activity of the chip during execution of the recipe. The other elements of FIG. 35 have been discussed previously.

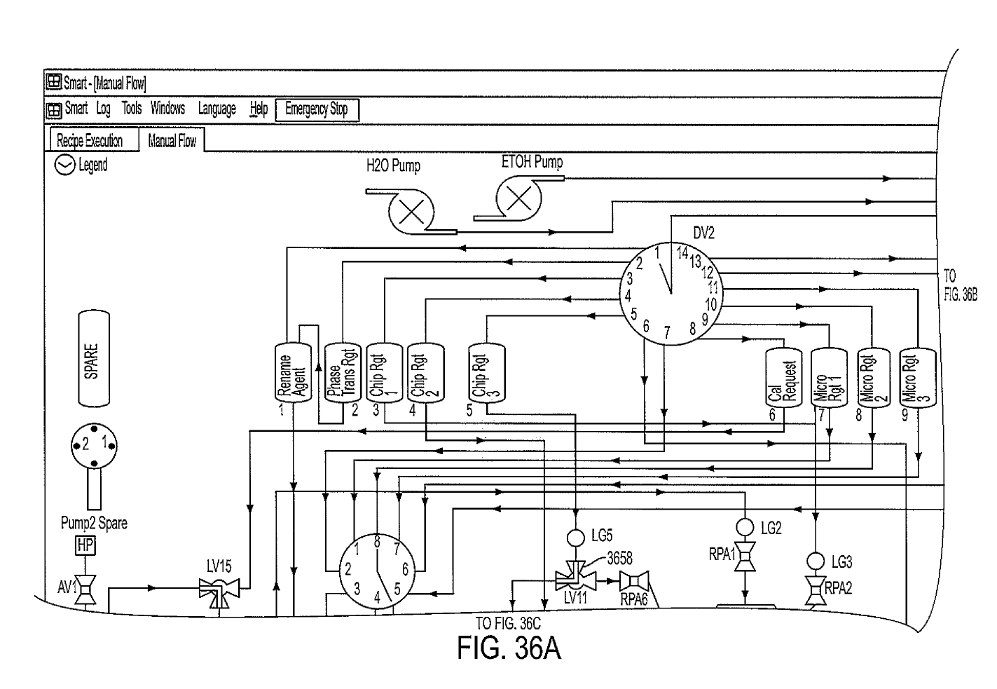

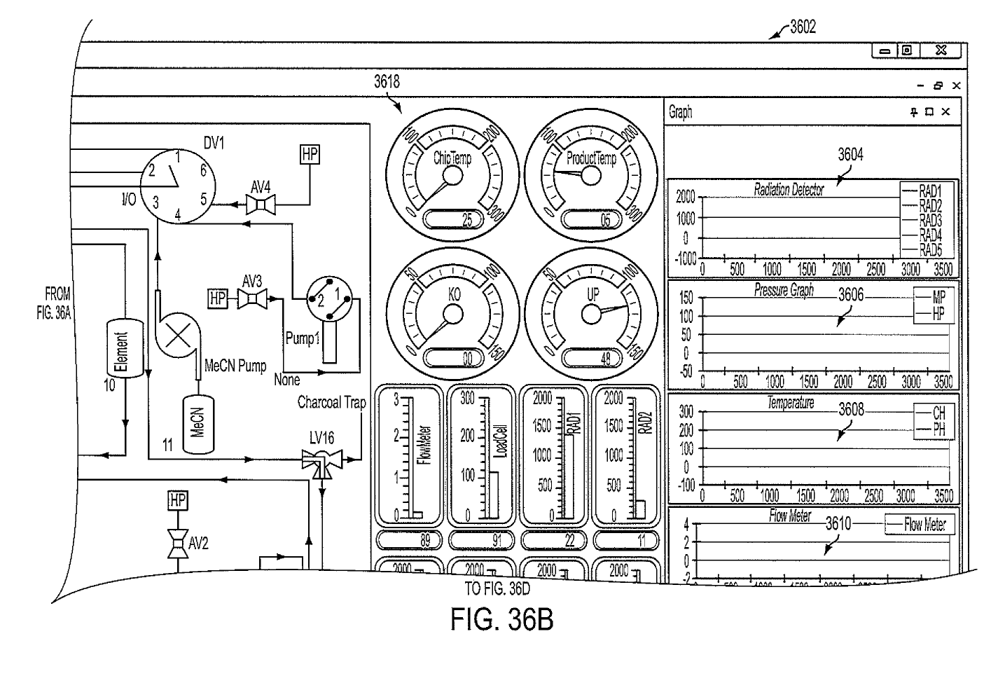

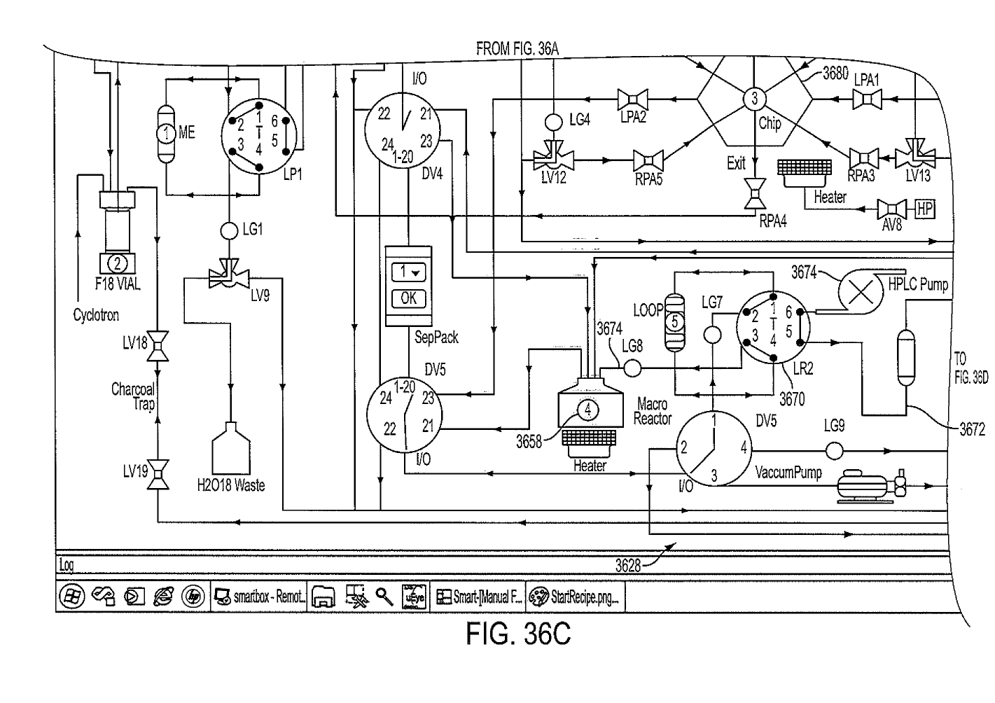

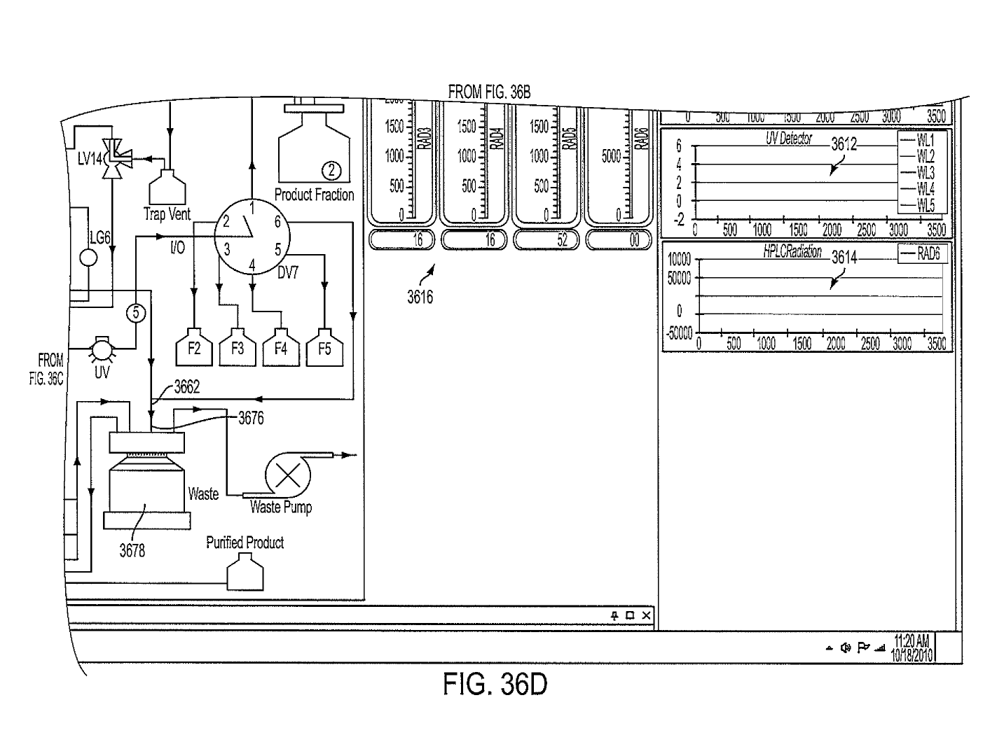

FIG. 36 illustrates an exemplary schematic and graphs of chemical synthesis according to an embodiment of the present invention. The diagram of FIG. 36 permits a user to control execution of a recipe. As shown in FIG. 36, a plurality of graphs 3602 include: radiation detector 3604; pressure graph 3606; temperature graph 3608, flow meter 3610; UV detector graph 3612; and HPLC radiation graph 3614. Also shown are a plurality of displays 3616 showing a level and/or status of a number of parameters and circular representations 3618. Partial schematic 3628 shows a diagram of the recipe execution apparatus.

Specifically, the diagram of recipe execution 3628 shows a system for displaying a status of a process, such as execution of a recipe. As shown in 3628, the system has one or more first components, including valves, pumps (3674), HPLC column, chip (3680), macro reactor (3658), filters and other hardware elements that are used for the execution of the recipe. There are also one or more conduit paths (e.g., 3672, 3662), such as tubing, plumbing, channels and other mechanism for transporting fluid (a fluid may be a liquid, a gas or combination of liquid and gas; or other matter that demonstrates similar flow properties) connecting the components, such that the conduit paths provide a conduit for liquid through the paths. There are also one or more sensors (e.g., 3676), that correspond to an associated component. The sensors sense when fluid is present at the component and provides a status signal.

A processor (not shown in FIG. 36; but as shown in FIG. 2 and FIG. 3 herein) is operatively coupled to receive the status signals from pre-programmed logic that is stored in memory (as described herein and shown in FIG. 2 and FIG. 3), the status being confirmed by sensors (e.g., 3676) and process the received status signals and a display unit (not shown in FIG. 36; but shown in FIG. 2 and FIG. 3 herein), operatively coupled to the processor displays a graphical representation of the status signals showing a path of fluid flow through the conduit paths and elements.

The system of 3628 is a graphical representation of the path status of fluids through channels. This representation results from the execution of the recipe according to programmed logic steps stored in memory and executed by the processor to run the recipe. Thus, a user or operator can view the status of execution of a recipe by viewing representation 3628. However, while the representation 3628 is a representation of the current status of the reaction, it is not merely a computer-generated simulation; but, is the representation of fluid path, that is confirmed by sensor output to a processor, which utilizes an algorithm to generate a display of the fluid flow. Thus, a “real-time” or “live” indication of the progress of the synthesis is provided. The fluid path of fluid through the system may be represented by a different color such as green for fluid being present and red for no fluid being present, flashing path, dashed line or any other suitable indication mechanism. As shown in FIG. 36, fluid paths 3674 and 3662 may be color coded to show whether fluid is travelling through the conduit or not. Components, such as macro reactor 3658, chip 3670, waste 3678 and others, may have an associated sensor (e.g., sensor 3676 is associated with waste module 3678) to confirm the operational status of the component and fluid path. For example, the operational status of waste module 3678 and the fluid path 3662 can be represented by a color scheme or other graphic showing the status of waste module 3678 and fluid conduit 3662. The processor, as shown in previous figures is adapted to execute program code to identify the status of the execution of a recipe and provide an output of the status, which is shown as representation 3628. A sensor 3676 coupled to the waste module 3678 can provide additional signals to the processor.

For example, when a valve is turned, the status of that valve is updated to the GUI. Each element, or hardware apparatus or component has a representation, indicating its present operational status. Thus, if a path is blocked, a new path is selected and depicted on the GUI. The representation is changing during the execution of the recipe since the operational status of the components and fluid paths are changing.

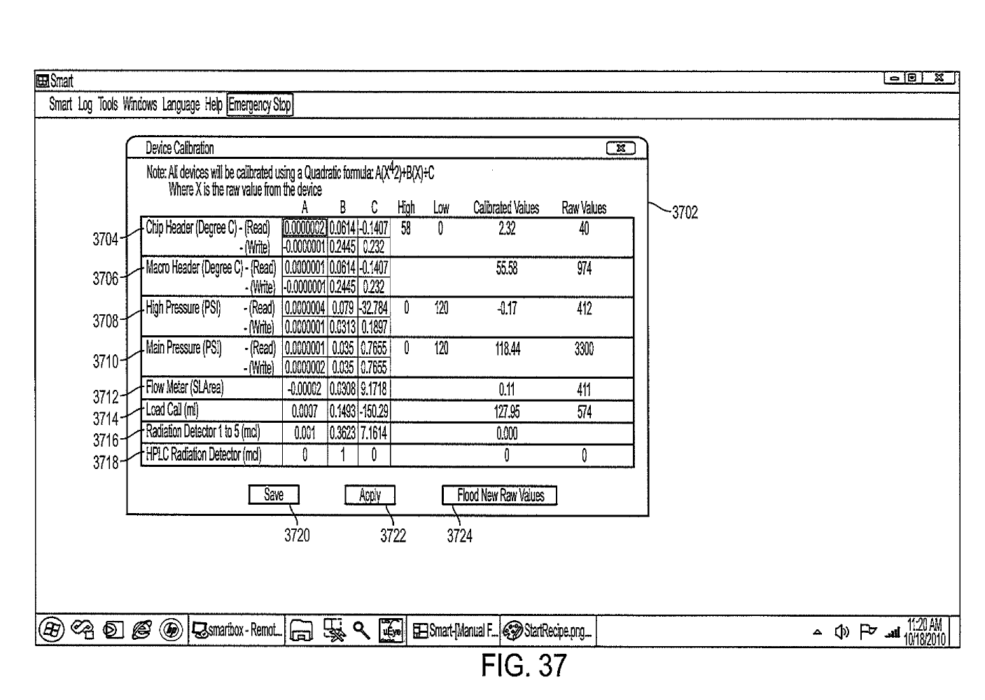

FIG. 37 illustrates an exemplary display of device calibration according to an embodiment of the present invention. Menu display 3702 shows a plurality of parameters, which include, for example: chip heater 3704; macro heater 3706; high pressure 3708; main pressure 3710; row meter 3712; load cell 3714; radiation detector 3716; and HPLC radiation detector 3718. Also shown are menu buttons save 3720, apply 3722 and new raw values 3724.

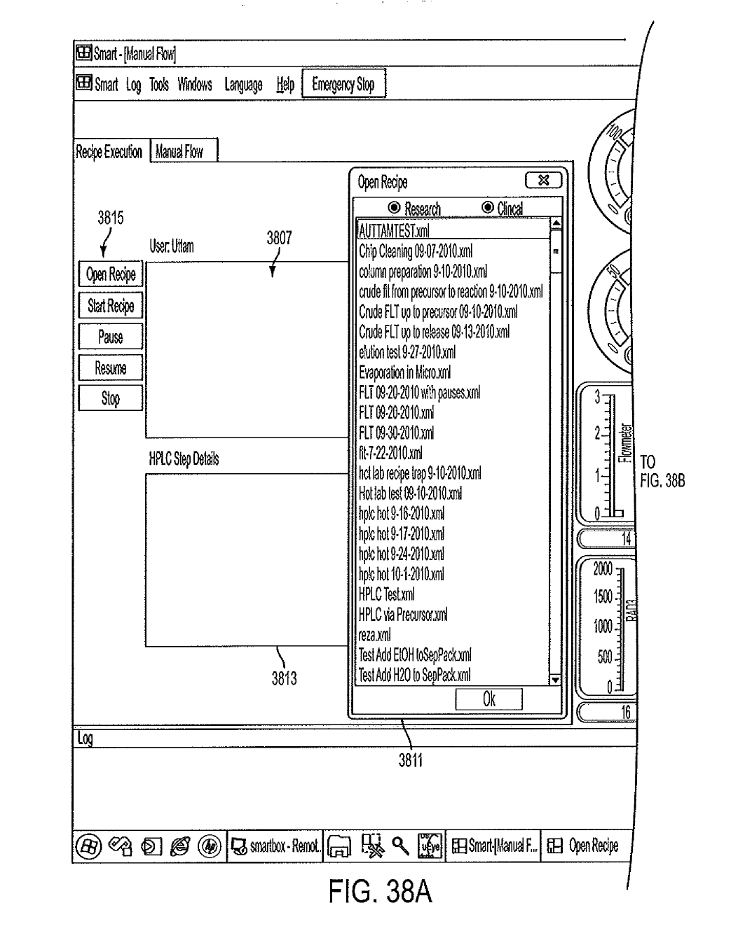

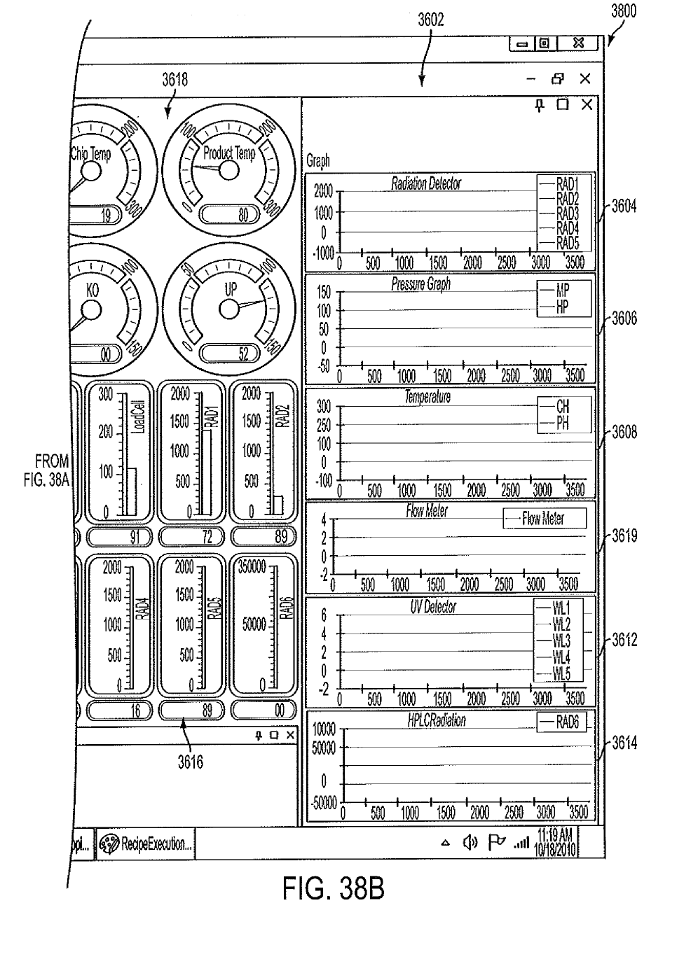

FIG. 38 illustrates an example of a screen shot of opening a recipe according to an embodiment of the present invention. Similar to FIG. 36, FIG. 38 shows a plurality of graphs 3602 include: radiation detector 3604; pressure graph 3606; temperature graph 3608, flow meter 3610; UV detector graph 3612; and HPLC radiation graph 3614. Also shown are a plurality of displays 3616 showing a level and/or status of a number of parameters and circular representations 3618. A user may open a recipe as shown by menu buttons 3815. Area 3807 permits input of steps or other information. Area 3813 permits entry of step details, for example HPLC. Area 3811 shows a listing of actions or steps to execute the desired recipe.

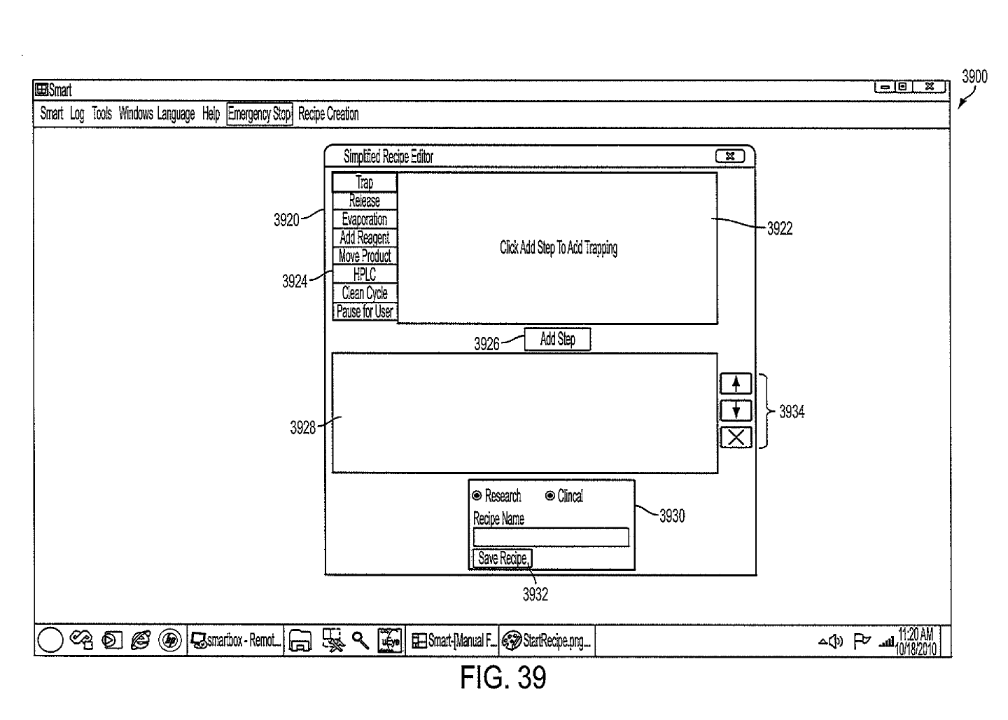

FIG. 39 shows an example of a chemical reaction (recipe) editing screen 3920 according to an embodiment of the present invention. A user may add a step or steps in area 3922 to the list of steps 3924, which are displayed using menu button “Add step” 3926 Input area 3928 and directional keys 3934 are also used to edit a recipe. Menu 3930 provides additional input and “save” button 3932 permits storing of the edited recipe.

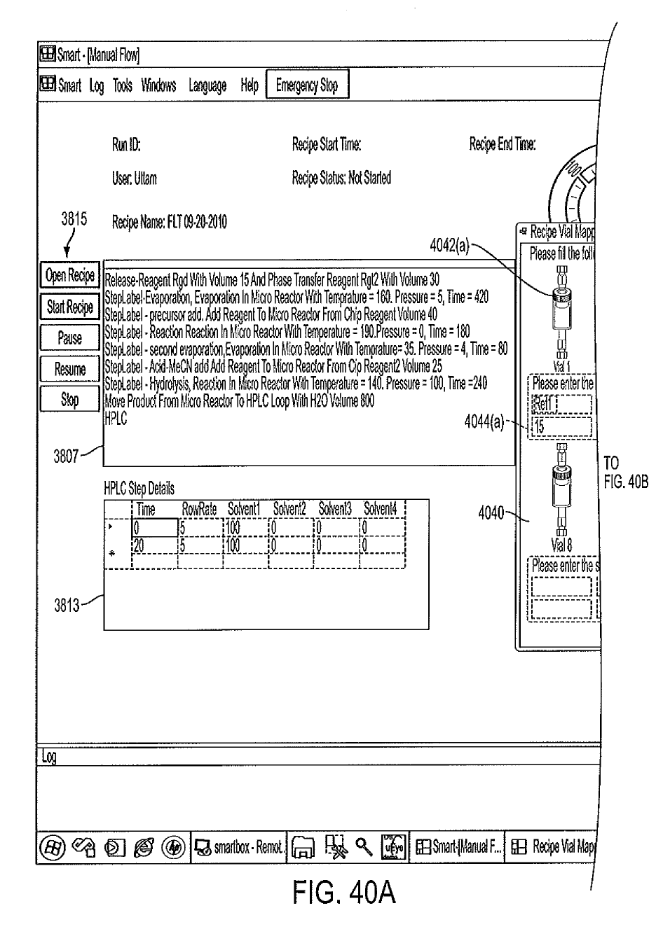

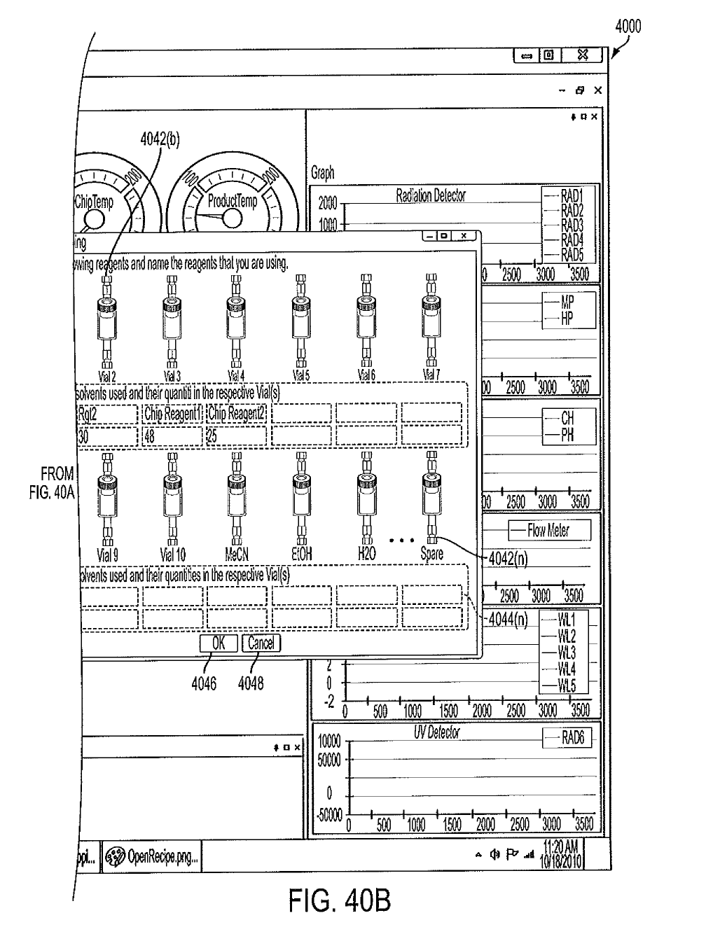

FIG. 40 illustrates an example of a screen shot according to an embodiment of the present invention. It includes a recipe vial mapping portion 4040 that includes identification of a plurality of reagents 4042(a) . . . (n) where “n” is any suitable number, as well as associated input portion 4044 that permits input of a reagent and a volume of the reagent. The other elements of FIG. 40 have been discussed in relation to FIG. 38.

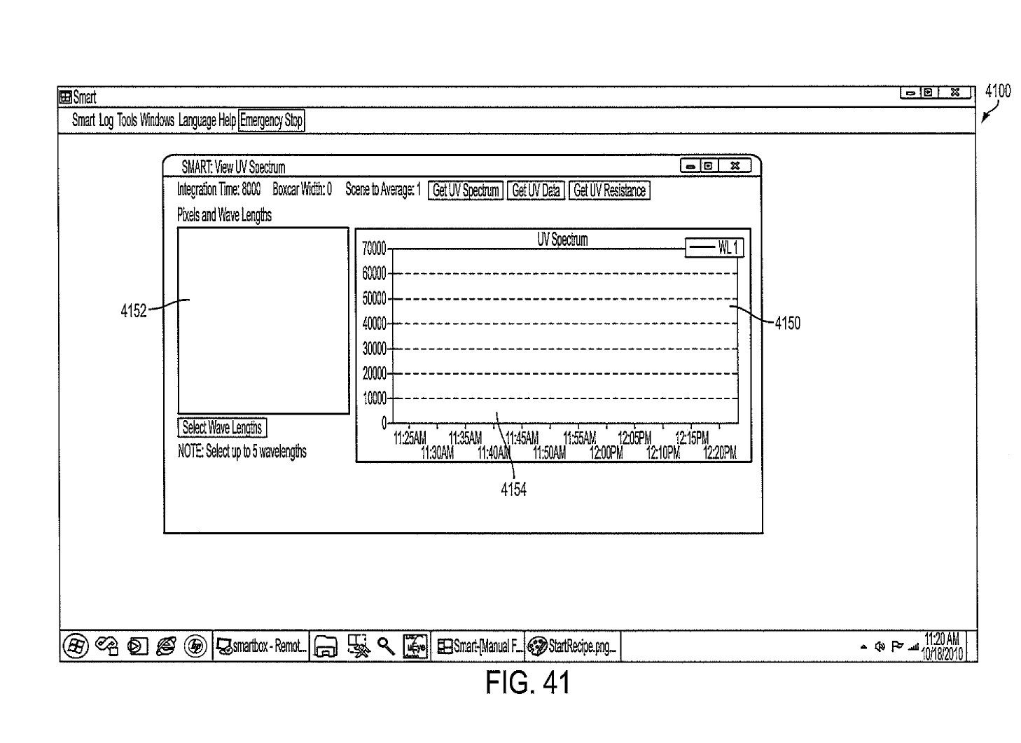

FIG. 41 illustrates an example of a screen shot of a view of UV spectrum 4150 according to an embodiment of the present invention. A pane 4152 permits a listing of wavelengths and area 4154 shows X axis and Y axis to plot the UV spectrum.

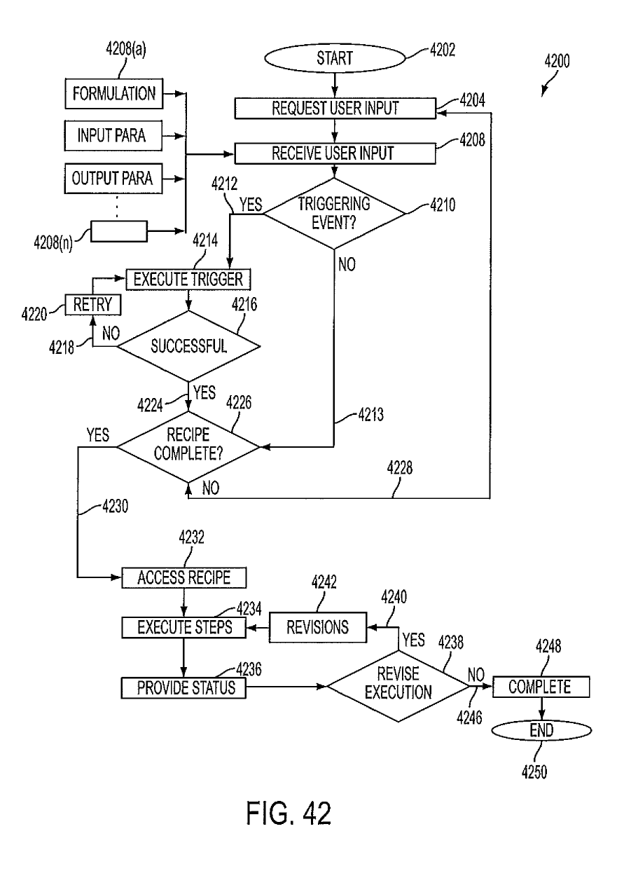

FIG. 42 shows an example 4200 of a series of steps, or algorithm, or steps that may be written as program code (source code), or steps that have been compiled (object code) or a combination thereof that may be executed. The steps may be stored in a recorded medium, such as a non-transitory computer readable medium, in a local or remote storage location or accessed via a network (as shown in FIGS. 1-3 herein).

The series of steps 4200 begins with start step 4202. User input is requested, as shown by step 4204. This user input may include, for example, what chemical is to be synthesized, what chemicals are available, has the recipe been executed previously and other information. The user input is received, as shown in step 4206. The input may be received via a keyboard or other input module and/or accessed from a storage location, which may be local or remote. Examples of received user input include parameters 4208(a) . . . (n) (where “n” is any suitable number). These parameters may be similar to the parameters shown in FIG. 4 and can include, for example: formulation data; input parameters; output parameters; equipment; tools; chemicals; yield; and chemistry.

A determination is made whether there is any “triggering event”, as shown in step 4210. A triggering event is an action or step, or series of steps, or routine or activity that occurs prior to execution of the recipe a recipe. For example, a triggering event could be that the operator turns on an apparatus before starting execution of the recipe.

If there is a triggering event, “yes” line 4212 shows that the triggering event is executed, or performed, as shown in step 4214. A determination is made whether the triggering event was performed correctly and/or whether there are any additional triggering events to be performed, as shown in step 4216. If the triggering event(s) are not successfully completed, “no” line 4218 shows that retry step 4220 is reached. This step will attempt to re-execute the triggering event, or alternatively, execute any additional triggering events. When all the triggering events have been successfully executed, “yes” line 4224 shows that a determination is made whether the recipe is complete, as shown in step 4226. If not, “no” line 4228 shows additional user input is requested, as shown in step 4204. Also, determining if the recipe is complete, as shown in step 4226, may also be reached via line 4213 from triggering event determination step 4210.

If the recipe is complete, “yes” line 4230 shows that a recipe is accessed, as shown in step 4232. This recipe may be accessed from a memory or storage location or from user input. The recipe is executed, as shown in step 4234 and a status condition is provided, as shown in step 4236. The execution of the recipe can be revised, as shown in step 4238 and “yes” line 4240 leading to revisions in the execution, as shown in step 4242. If the execution of the recipe is not revised, “no” line 4246 shows that completion of the recipe execution occurs, as shown in step 4248 and end step 4250 is reached. Another embodiment is directed to sorting the processing steps, based on the status of the triggering event. In other words, the presence of a triggering event will determine the sequence of processing. In another embodiment, the triggering step is necessary prior to execution of other steps.

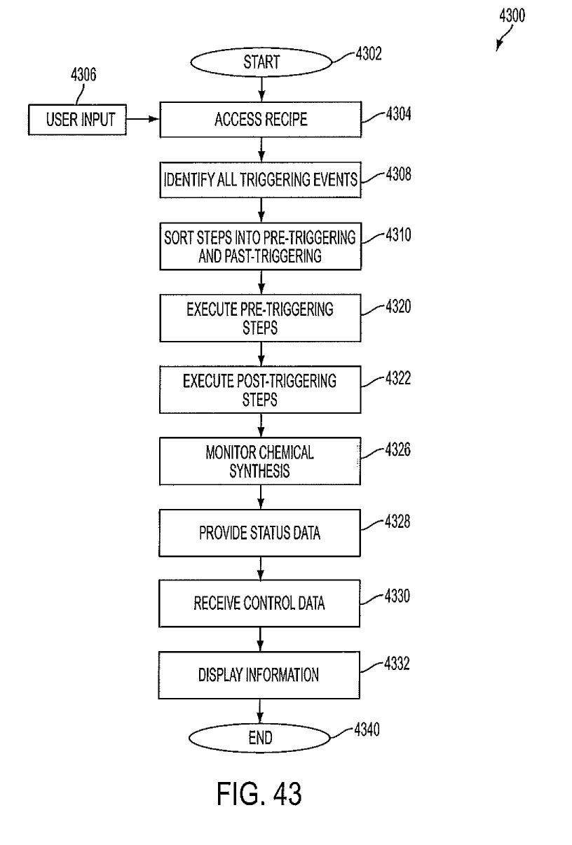

FIG. 43 shows an embodiment of the present invention in which one or more triggering events are used. Similar to the steps of FIG. 42, the steps 4300 shown in FIG. 43 may be stored on a computer-readable medium, such as a non-transitory medium and may be executed by a processor as described in FIGS. 2 and 3 herein. Specifically, the series of steps 4300 begin, as shown by start step 4302. A recipe is accessed, as shown in step 4304, the recipe including a sequence of one or more processing steps and user input, as shown in step 4306, for the chemical synthesis. The recipe is executed by identifying one or more triggering events, as shown in step 4308 and sorting the user input into pre-triggering steps and post-triggering events, as shown in step 4310. The pre-triggering steps are executed, as shown in step 4320 and then the post-triggering steps are executed, as shown in step 4322. The chemical synthesis is monitored, as shown in step 4326 and status data, indicating a status of the execution, is provided, as shown in step 4328. The status data provided to a user enables input of control data to modify execution based on the status data or user-initiated modification. Information related to the status of the execution is displayed, as shown in step 4332 and end step 4340 shows the end of the process.

As described herein, one embodiment of the present invention is directed to an interface between a user and a chemical system for synthesizing radiochemicals such as a microfluidic device. In particular, a computer program may communicate with the user/operator and the chemical system. It allows the user to input the parameters of the synthesis via a simple, intuitive and singular interface. The program then instructs the chemical system to follow these inputs and carry out the synthesis. A user does not have to operate each component of the chemical system.

In another embodiment, the present invention is a system comprising a microfluidic device, a computer and the computer program. The microfluidic device may comprise all of the components of the device shown and described in PCT/US2008/060267 and the system may be portable.

In another embodiment, the present invention is a method for synthesizing a radiochemical using the computer program and interface described herein.

Preferably, the program to execute the desired recipe is carried out on a computer. The computer may include a processing device, a system memory, a system bus coupling the system memory to the processing device, a storage device, such as a hard disk drive, a magnetic disk drive, e.g., to read from or write to a removable magnetic disk, and an optical disk drive, e.g., for reading a CD-ROM disk or to read from or write to other optical media. The storage device may be connected to the system bus by a storage device interface, such as a hard disk drive interface, a magnetic disk drive interface and an optical drive interface. Although this description of computer-readable media refers to a hard disk, a removable magnetic disk and a CD-ROM disk, it should be appreciated that other types of media that are readable by a computer system and that are suitable to the desired end purpose may be used, such as magnetic cassettes, flash memory cards, digital video disks, etc.

The computer is in communication with the chemical system or microfluidic reactor. “In communication” means that the computer is physically (e.g., wired) or wirelessly connected to the chemical system and may connected to the reactor directly or via other media. Various sensors (e.g., flow sensors, liquid-gas interface sensors, radioactivity sensors, pressure sensors, temperature sensors, and the like) and other apparatus components (e.g., valves, switches, etc.) can be integrated into the chemical system and be in communication with the computer for process control and monitoring purposes.

The computer, or other external input device, may be coupled to a program storage device and to a controller. The controller may be coupled to at least one valve on the synthesis chip, an inert gas delivery source, a temperature control system, a pressure monitor, and/or a vacuum system.

In accordance with an embodiment of the present invention, the computer program and interface may be in communication with a PC and a Programmable Logic Controller (PLC), such as a Ladder Logic PLC. The hardware of the synthesis system may be controlled by the PLC. The PLC may control all of the I/O in the reactor using, for example, analog outputs, analog inputs, relay outputs, digital inputs, digital outputs, and a Ladder Logic program.

The computer program may be a software control program written in Visual Basic but may be written in other programming language. The standard PC, using, for example, a Visual Basic control software, may control the PLC and precision syringe pumps using serial communication. This provides a very detailed graphical interface allowing visualization of what is happening in the hardware, and controlling the various valves, pumps, heaters and other components.

As described in more detail below, the desired reaction values may be input at the start of the reaction. For example, the user may set the flow times, reaction times, temperatures, pressures and volumes before starting the reaction. The script may then read all the information and adjust the synthesis to run accordingly.

A user may enter commands and information into the computer. A display device, such as a monitor, having a display screen, is connected to the system bus via an interface. In addition to the display screen, the computer can also include other peripheral output devices. The computer can operate in a networked environment using logical connections to one or more remote computer systems, such as a server, a router, a peer device or other common network node, and such a system can include any or all of the elements described relative to the computer.

When used in a local area network (LAN) environment, the computer is connected to the LAN through a network interface. When used in a WAN networking environment, the computer typically includes a modem or other means for establishing communications over a WAN, such as the Internet. The modem, which may be internal or external, may be connected to the system bus via the serial port interface. In a networked environment, program modules depicted relative to the computer, or portions thereof, may be stored in the remote memory storage device. It should be appreciated that the network connections shown are exemplary and other means of establishing a communications link between the computer systems may be used. It should also be appreciated that the application module could equivalently be implemented on host or server computer systems other than the computer, and could equivalently be transmitted to the host computer system by means other than a CD-ROM, for example, by way of the network connection interface. Program modules stored in the drivers of the computer system may control how the general computer system functions and interacts with the user, with I/O devices or with other computers. Program modules may include routines, operating systems, target application program modules, data structures, browsers, and other components.

It should be appreciated that there are many computers and operating systems which may be used in practicing an exemplary embodiment.

The method may be embodied in the form of computer-implemented processes and apparatuses for practicing those processes. The above may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing embodiments of the invention. Reprogrammable storage (e.g., flash memory) can be updated to implement embodiments of the present invention. The above can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing embodiments of the present invention. When implemented on a general-purpose microprocessor, the computer program code segments may configure the microprocessor to create specific logic circuits in whole or in part.

The present invention provides an interface for allowing more efficient interfacing and operation of a chemical system comprising “hardware,” such as a system for synthesizing radiochemicals. Rather than having to learn how to operate and control each mechanical component of the chemical system, the chemist or operator of the chemical system can simply enter the parameters that he or she is familiar with. The system would then operate the hardware based on the chemist's inputs. It will be understood that the software, computer program and interface “transform” an article. In particular, they instruct the microreactor to carry out a chemical reaction that may transform one chemical into another.

The user interface asks the user questions that are only relevant to the chemical process (reactions, reagent combinations, solvent exchange, etc.) and based on the answers, sends the correct signals to the hardware (pumps, valves, heaters, which otherwise, the chemist would have to control directly). Embodiments of the present invention add another layer in the software above the one where all traditional radiochemistry applications have stopped. The user provides the system only with information relevant to the chemical process (reagents, reactions, solvents, times, temperatures, pressures). The system then automatically determines which hardware needs to be used to achieve this process. Then it compiles a recipe and executes it, providing the user with in-process information that is relevant to the chemist (pressure, temperature, radiation levels). None of the hardware components require user interaction or user's detailed knowledge of the plumbing or wiring schematics of the instrument, which is the industry standard.

The interface and method for using the interface are shown in FIGS. 1-41.

As shown in FIGS. 1-41, the interface may comprise a plurality of screens. These screens are preferably displayed on a computer monitor (216).

The first screen, shown in FIGS. 6-33, may comprise headings such as “reagent manager” and “new recipe”. Under these headings may be a plurality of inputs and/or outputs. The inputs (i.e., “reagent manager”) may comprise a plurality of areas (such as cells) for inputting information. The outputs (i.e., “new recipe”) may comprise an area for outputting information. Such output areas may display a summary of what has been input. The outputs may be in various forms including graphs, charts, tables, calculations, etc. and may be displayed on other screens (see e.g., FIGS. 34 and 35).

The cells may be labeled with various indicators. For example, an isotope input may be labeled with the indicator, “Isotope,” which may be the name of the isotope to be synthesized (see e.g., FIGS. 6 and 7). Such an isotope may be F-18 but may be other radiochemical isotopes used in PET. A second cell of the isotope input may receive an amount (e.g., volume or mass) of the isotope. This indicator may read “ml” to indicate that volume in ml is required.

The cells may be “blank” or may comprise a plurality of existing selections from which to choose; for examples, a “drop down” menu. As shown in FIG. 6, the isotope input may comprise a third cell that is a drop down menu listing various destinations for the isotope. Such destinations may include the ion exchanger, the microreactor, a macroreactor, HPLC and the SEP-PAK.

The inputs may also comprise a plurality of action buttons. For example, the isotope input may comprise a button for dispensing the isotope (the tipping over vial) or for deleting the inputted item from the process (the “X”). The remaining inputs (i.e., inputs 1-11) may also include a plurality of cells for inputting information, amounts, destinations, etc., as well as action buttons.

The first screen may also comprise a plurality of outputs that may be under the title, “new recipe.” These outputs may be arranged in a table or in rows with destinations such as ion-exchange, microreactor, macroreactor, SEP-PAK, product vial, HPLC, waste, etc. on the left-hand or right-hand side.

Essentially, the rows shown under new recipe track what has been input under reagent manager, show the input's destination and its place in the process sequence. For example, a user inputs, into the isotope input, 2 ml of F-18, with a destination of the ion-exchange column (FIG. 8), and hits the action button, “dispense isotope.” As shown in FIG. 9, along the ion-exchange row of the “new recipe” section, a cartoon of a test tube labeled F-18, appears. This helps the user keep track of the process he or she is designing.

In continuing the process of using the interface, the user may then want to add reagents to the reactor. FIG. 10 shows a first menu that allows a user to easily add a reagent and/or release that reagent to the microreactor. The menu may be a pop-up menu and may be automatically activated or activated by the user. The user may click on “release to microreactor” whereupon a second menu appears (FIG. 11). Such a menu may be a pop-up menu and may be automatically activated or activated by the user. The user then may input the chemical or solution and the amount to release to the reactor. As shown in FIG. 12, for example, the user may input 5 ml of K₂CO₃ to the reactor. The user may then input additional reagents such as 5 ml of K222. Upon doing so, the “new recipe” section now shows F-18, K₂CO₃ and K222 in the ion-exchange column row of the table (FIG. 13). These additional reagents may now be shown in inputs 1 and 2 of the reagent manager section, with their destination being the ion-exchange column. (If additional reagents were input, they would also be shown in inputs 3 and 4 of the reagent manager section.) As shown in FIG. 14, the new recipe section may now display a downward arrow, which means that the process will proceed to the next step, involving another component of the chip.

As shown in FIG. 15, a third menu may be displayed. This third menu may be a pop-up menu and may be automatically activated or activated by the user. This third menu may include the options “add reagent,” “move reagent,” “start reaction,” or “start evaporation.”

As shown in FIG. 16, if a user selects, “start evaporation,” a fourth menu may appear. This fourth menu may be a pop-up menu and may be automatically activated or activated by the user. This menu may give the option to start the evaporation (“start condition”), adjust the temperature and duration, etc. After the user enters these values and executes the process (e.g., by hitting “enter”), the “new recipe” section shows that evaporation will start after the reagents are mixed.

As shown in FIG. 17, the user then may enter the precursor and the desired amount into one or more of the inputs (e.g., input 5). The third pop-up menu may again appear or be activated by the user. The user may then select the “start reaction” option (FIG. 19).

As shown in FIG. 20, the fourth pop-up menu may then appear. The user provides the inputs as he or she did in the evaporation step, described above. After inputting the values into the fourth menu, fluorination is shown in the “new recipe” section (FIG. 21).

The third pop-up menu may then appear or be activated by the user (FIG. 22). The user may then select “add reagents,” whereupon a second pop-up menu may appear (FIG. 23). As previously described, the user may enter the appropriate reagent(s) and amount(s) (FIG. 24). After being input, these additional reagents may be shown in the “new recipe” section. They also may be shown in the reagent manager section (e.g., inputs 5 and 6) with their destinations being the microreactor. (FIG. 25) The “new recipe” section may show the chemical process taking place; e.g., hydrolysis (FIG. 26). Evaporation, precursor fluorination and acid are now shown in the microreactor row of the new recipe table. F-18, K2CO3 and K222 are now shown in the ion-exchange row.

A fifth menu, optionally titled, “solvent manager,” may appear or be activated by the user (FIG. 28). This fifth menu may be a pop-up menu. This allows the user to input a ratio of solvents and the time at which these ratios take effect in the reaction. For example, the user may wish to have 40% K₂CO₃ and 60% K222 at the beginning of the reaction but have 80% K₂CO₃ and 20% K222 at 30 seconds.

The “new recipe” section then shows the purification process in the HPLC row (FIG. 29). The “compile recipe” button may then be activated (FIG. 30). The “new recipe” section will then show the steps of the synthesis that will take place (FIG. 31). For example, F-18, K₂CO₃ and K222 to the ion-exchange column, followed by the evaporation step. Next, is delivery of the precursor to the microreactor, followed by the fluorination step. Next, is acidic hydrolysis of the fluorinated intermediate followed by purification wherein the raw product is subjected to HPLC. Finally, the purified product will be directed into a “Purified Product” vial and the remaining liquid into the “General Waste” vial. The “new recipe” section will include the sequence of steps and the time interval for each. The user will then have the option of saving the sequence, which may bring up a sixth menu, which may be a pop-up menu (FIG. 32).

After the new recipe is saved, the user will have the option of running the new recipe (FIG. 33). This brings up a second screen. The second screen includes the new recipe portion but with the new name of the reaction. It also includes various graphs showing the progress of the reaction and conditions such as the temperature, pressure, activity, etc.

When the user hits the “execute recipe” button, the interface asks the user to load the specified quantities of reagent into the microreactor (FIG. 34). Once this is completed, the user may begin the reaction. The graphs, etc., of the second screen show the progress of the reaction and the reaction conditions (FIG. 35).

Various embodiments of the present invention will now be described:

One embodiment of the present invention is directed to a non-transitory computer-readable medium storing a program that when executed performs a method for chemical synthesis (“the method”). The method includes accessing a recipe, the recipe including a sequence of one or more processing steps for the chemical synthesis. The processing steps including one or more pre-isotope steps and one or more post-isotope steps. The recipe is executed by sorting the processing steps; and executing the one or more pre-isotope steps prior to the one or more post-isotope steps. The method also includes monitoring the chemical synthesis; providing status data, indicating a status of the execution; enabling input of control data to modify execution based on the status data or user-initiated modification; and displaying information related to the status of the execution, that includes at least one graphical representation of a process action.

Another embodiment of the present invention is directed to the method described above and also includes accessing one or more user-defined parameters for the recipe.

Another embodiment of the present invention is directed to the method described above, wherein the monitoring step further includes sensing one or more conditions of the chemical synthesis.

Another embodiment of the present invention is directed to the method described above, wherein the control data includes response data to one or more pre-selected questions.

Another embodiment of the present invention is directed to the method described above, wherein the control data includes responses to instructions displayed for a user to execute.

Another embodiment of the present invention is directed to the method described above, wherein sorting the process steps is performed prior to execution of any process step.

Another embodiment of the present invention is directed to the method described above and also includes displaying a drop-down menu that provides additional recipe parameters.

Another embodiment of the present invention is directed to the method described above, wherein the recipe is modified based on the additional recipe parameters.

Another embodiment of the present invention is directed to the method described above, and also includes displaying the process of the modified recipe.

Another embodiment of the present invention is directed to the method described above, and also includes accessing a ratio of solvents and executing an operation for creating a mixture of chemicals at one or more time intervals.

Another embodiment of the present invention is directed to the method described above, wherein the chemical synthesis a radiosynthesis system.

Another embodiment of the present invention is directed to the method described above, wherein the chemical synthesis a microfluidic system.

Another embodiment of the present invention is directed to the method described above, and also includes detecting a code on a consumable package; and selecting a recipe to execute based on the code.

Another embodiment of the present invention is directed to the method described above, and also includes selecting a recipe to execute from a list of at least one recipe displayed on a graphical user interface.

Another embodiment of the present invention is directed to the method described above, and also includes calculating at least one yield of the chemical synthesis, wherein the yield calculation includes reactor detector readings from one or more processing steps.

Another embodiment of the present invention is directed to the method described above, and also includes compiling the recipe based on at least one user-entered answer to one or more chemistry-related questions; verifying that the recipe does not contain conflicting processes; and storing the recipe after verification.

Another embodiment of the present invention is directed to the method described above, and also includes optimizing the recipe to run two or more processing steps in parallel, wherein the processing steps are synchronized so that the parallel processing steps complete substantially simultaneously.

Another embodiment of the present invention is directed to the method described above, and also includes performing a cleaning step of cleaning portions of chemical synthesis apparatus, wherein the cleaning step cleans only those portions of the chemical synthesis apparatus that performed processing steps.

Another embodiment of the present invention is directed to the method described above, and also includes mixing at least two reagents, wherein the reagents are mixed in proportions according to the recipe.

Another embodiment of the present invention is directed to the method described above, and also includes priming one or more reagents prior to an associated processing step that utilizes the reagent, wherein the primed reagent is available for the chemical synthesis for the associated processing step.

Another embodiment of the present invention is directed to the method described above, and also includes storing a subset of the information related to the status of the execution; calculating performance information from the stored information; and displaying the calculated performance information.

Another embodiment of the present invention is directed to the method described above, and also includes transmitting real-time video data from a chemical synthesis module to a display module.

Another embodiment of the present invention is directed to the method described above, and also includes providing instructions to a user at a selected processing step requesting one or more actions by the user.

Another embodiment of the present invention is directed to the method described above, and also includes detecting an alert condition; and displaying an alert indication.

Another embodiment of the present invention is directed to the method described above, and also includes detecting a radiation level during execution of the recipe; terminating execution of the recipe when the detected radiation level exceeds a predetermined threshold; and displaying an alert indication.

Another embodiment of the present invention is directed to the method described above, and also includes running a self-test to confirm execution of the recipe is appropriate.

Another embodiment of the present invention is directed to the method described above, and also includes transmitting a communication related to execution of the recipe over a network.

Another embodiment of the present invention is directed to the method described above, and also includes monitoring the usage of at least one consumable; and generating an alert indication when the amount of available consumable is below a predetermined threshold.

Another embodiment of the present invention is directed to an electronic storage medium storing a program that when executed performs a method for chemical synthesis, (“the chemical synthesis method”). The chemical synthesis method includes accessing a recipe, the recipe including a sequence of one or more processing steps for the chemical synthesis, executing the recipe by sorting the processing steps into one or more pre-isotope steps and one or more post-isotope steps; monitoring the chemical synthesis; providing status data, indicating a status of the execution; enabling input of control data to modify execution based on the status data or user-initiated modification; and displaying information related to the status of the execution, that includes at least one graphical representation of a process action.

Another embodiment of the present invention is directed toward the chemical synthesis method and also includes introducing one or more additional isotope steps.

Another embodiment of the present invention is directed toward the chemical synthesis method and also includes displaying information relevant to a currently occurring operational step of the chemical synthesis.

Another embodiment of the present invention is directed toward the chemical synthesis method and also includes displaying information relevant to control of a currently occurring operational step of the chemical synthesis.

Another embodiment of the present invention is directed toward the chemical synthesis method and also includes determining performance of the execution; and comparing the performance of the execution to a performance value of a previous execution of the same method.

Another embodiment of the present invention is directed toward the chemical synthesis method and also includes displaying the information related to the status of the execution on a second display device.

Another embodiment of the present invention is directed toward the chemical synthesis method and also includes displaying one or more control inputs to a user; and utilizing the control input during the execution.

Another embodiment of the present invention is directed toward the chemical synthesis method, wherein the one or more control inputs displayed to the user are based on an authorization level of the user.

Another embodiment of the present invention is directed to a non-transitory computer-readable medium storing a program that when executed performs a method for chemical synthesis, that includes accessing a recipe, the recipe including a sequence of one or more processing steps for the chemical synthesis, executing the recipe by:
identifying one or more triggering events; and
executing the one or more triggering events;
monitoring the chemical synthesis; providing status data, indicating a status of the execution; enabling input of control data to modify execution based on the status data or user-initiated modification; and displaying information related to the status of the execution. Another embodiment is directed to sorting the processing steps, based on the status of the triggering event. In other words, the presence of a triggering event will determine the sequence of processing. In another embodiment, the triggering step is necessary prior to execution of other steps.

Another embodiment of the present invention is directed to a system for displaying a status of a process that includes one or more components; one or more conduit paths connecting one or more of the first components, the conduit paths providing a conduit for fluid; one or more sensors, each sensor corresponding to an associated component, the sensors sensing when fluid is present at the component and providing a status signal;
a processor, operatively coupled to receive the status signals from the sensors and process the received status signals; and a display unit, operatively coupled to the processor to display a graphical representation of the status signals showing a path of fluid flow through the conduit paths.

It will be appreciated from the above that the invention may be implemented as computer software, which may be supplied on a storage medium or via a transmission medium such as a local-area network or a wide-area network, such as the Internet. It is to be further understood that, because some of the constituent system components and method steps depicted in the accompanying Figures can be implemented in software, the actual connections between the systems components (or the process steps) may differ depending upon the manner in which the present invention is programmed. Given the teachings of the present invention provided herein, one of ordinary skill in the related art will be able to contemplate these and similar implementations or configurations of the present invention.

It is to be understood that the present invention can be implemented in various forms of hardware, software, firmware, special purpose processes, or a combination thereof. In one embodiment, the present invention can be implemented in software as an application program tangible embodied on a computer readable program storage device, such as a non-transitory computer-readable medium. The application program can be uploaded to, and executed by, a machine, such as a processor, CPU or compiler, comprising any suitable architecture.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Although illustrative embodiments of the invention have been described in detail herein with reference to the accompanying drawings, it is to be understood that the invention is not limited to those precise embodiments, and that various changes and modifications can be effected therein by one skilled in the art without departing from the scope and spirit of the invention as defined by the appended claims.

A variety of modifications to the embodiments described will be apparent to those skilled in the art from the disclosure provided herein. Thus, the present invention may be embodied in other specific forms without departing from the spirit or essential attributes thereof.

Having thus described in detail various embodiments of the present invention, it is to be understood that the invention defined by the above paragraphs is not to be limited to particular details set forth in the above description as many apparent variations thereof are possible without departing from the spirit or scope of the present invention.

What is claimed is:

1. A non-transitory computer-readable medium storing a program that when executed performs a method for chemical synthesis, the method comprising:
accessing a recipe, the recipe including a sequence of one or more processing steps for the chemical synthesis, the processing steps including one or more pre-isotope steps and one or more post-isotope steps;
executing the recipe by:
sorting the processing steps; and
executing the one or more pre-isotope steps prior to the one or more post-isotope steps;
monitoring the chemical synthesis;
providing status data, indicating a status of the execution;
enabling input of control data to modify execution based on the status data or user-initiated modification; and
displaying information related to the status of the execution, that includes at least one graphical representation of a process action.

2. The method as recited in claim 1, further comprising:
accessing one or more user-defined parameters for the recipe.

3. The method as recited in claim 1, wherein the monitoring step further comprises:
sensing one or more conditions of the chemical synthesis.

4. The method as recited in claim 1, wherein the control data includes response data to one or more pre-selected questions.

5. The method as recited in claim 1, wherein the control data includes responses to instructions displayed for a user to execute.

6. The method as recited in claim 1, wherein sorting the process steps is performed prior to execution of any process step.

7. The method as recited in claim 1, further comprising:
displaying a drop-down menu that provides additional recipe parameters.

8. The method as recited in claim 7, wherein the recipe is modified based on the additional recipe parameters.

9. The method as recited as in claim 8 further comprising displaying the process of the modified recipe.

10. The method as recited in claim 7, further comprising:
accessing a ratio of solvents; and
executing an operation for creating a mixture of chemicals at one or more time intervals.

11. The method as recited in claim 1, wherein the chemical synthesis is a radiosynthesis system.

12. The method as recited in claim 1, wherein the chemical synthesis a microfluidic system.

13. The method as recited in claim 1, further comprising:
detecting a code on a consumable package; and
selecting a recipe to execute based on the code.

14. The method as recited in claim 1, further comprising:
selecting a recipe to execute from a list of at least one recipe displayed on a graphical user interface.

15. The method as recited in claim 1, further comprising:
calculating at least one yield of the chemical synthesis, wherein the yield calculation includes reactor detector readings from one or more processing steps.

16. The method as recited in claim 1, further comprising:
compiling the recipe based on at least one user-entered answer to one or more chemistry-related questions;
verifying that the recipe does not contain conflicting processes; and
storing the recipe after verification.

17. The method as recited in claim 1, further comprising:
optimizing the recipe to run two or more processing steps in parallel, wherein the processing steps are synchronized so that the parallel processing steps complete substantially simultaneously.

18. The method as recited in claim 1, further comprising:
performing a cleaning step of cleaning portions of chemical synthesis apparatus, wherein the cleaning step cleans only those portions of the chemical synthesis apparatus that performed processing steps.

19. The method as recited in claim 1, further comprising:
mixing at least two reagents, wherein the reagents are mixed in proportions according to the recipe.

20. The method as recited in claim 1, further comprising:
priming one or more reagents prior to an associated processing step that utilizes the reagent,
wherein the primed reagent is available for the chemical synthesis for the associated processing step.

21. The method as recited in claim 1, further comprising:
storing a subset of the information related to the status of the execution;
calculating performance information from the stored information; and
displaying the calculated performance information.

22. The method as recited in claim 1, further comprising transmitting real-time video data from a chemical synthesis module to a display module.

23. The method as recited in claim 1, further comprising providing instructions to a user at a selected processing step requesting one or more actions by the user.

24. The method as recited in claim 1, further comprising:
detecting an alert condition; and
displaying an alert indication.

25. The method as recited in claim 1, further comprising:
detecting a radiation level during execution of the recipe;
terminating execution of the recipe when the detected radiation level exceeds a predetermined threshold; and
displaying an alert indication.

26. The method as recited in claim 1, further comprising:
running a self-test to confirm execution of the recipe is appropriate.

27. The method as recited in claim 1, further comprising transmitting a communication related to execution of the recipe over a network.

28. The program of claim 1, further comprising:
monitoring the usage of at least one consumable; and
generating an alert indication when the amount of available consumable is below a predetermined threshold.

29. A non-transitory computer-readable medium storing a program that when executed performs a method for chemical synthesis, the method comprising:
accessing a recipe, the recipe including a sequence of one or more processing steps for the chemical synthesis,
executing the recipe by sorting the processing steps into one or more pre-isotope steps and one or more post-isotope steps;
monitoring the chemical synthesis;
providing status data, indicating a status of the execution;
enabling input of control data to modify execution based on the status data or user-initiated modification; and
displaying information related to the status of the execution, that includes at least one graphical representation of a process action.

30. The program as claimed in claim 29 further comprising introducing one or more additional isotope steps.

31. The program as claimed in claim 29 further comprising:
displaying information relevant to a currently occurring operational step of the chemical synthesis.

32. The program as claimed in claim 29, further comprising:
displaying information relevant to control of a currently occurring operational step of the chemical synthesis.

33. The program as claimed in claim 29, further comprising:
determining performance of the execution; and
comparing the performance of the execution to a performance value of a previous execution of the same method.

34. The program as claimed in claim 29, further comprising displaying the information related to the status of the execution on a second display device.

35. The program as claimed in claim 29, further comprising:
displaying one or more control inputs to a user; and
utilizing the control input during the execution.

36. The program as claimed in claim 35, wherein the one or more control inputs displayed to the user are based on an authorization level of the user.

37. A non-transitory computer-readable medium storing a program that when executed performs a method for chemical synthesis, the method comprising:
accessing a recipe, the recipe including a sequence of one or more processing steps and user input for the chemical synthesis;
executing the recipe by:
identifying one or more triggering events; and
sorting the user input into pre-triggering steps and post-triggering events;
executing the pre-triggering steps prior to the post-triggering steps;
monitoring the chemical synthesis;
providing status data, indicating a status of the execution;
enabling input of control data to modify execution based on the status data or user-initiated modification; and
displaying information related to the status of the execution.

38. The method as recited in claim 37, further comprising performing the steps of the recipe based on the one or more triggering events.

39. A system for displaying a status of a process comprising:
one or more components;
one or more conduit paths connecting one or more of the first components, the conduit paths providing a conduit for fluid;
a processor, operatively coupled to receive the status signals from the one or more components and process the received status signals; and
a display unit, operatively coupled to the processor to display a graphical representation of the status signals showing a path of fluid flow through the conduit paths.

40. The system as claimed in claim 39, further comprising one or more sensors, each sensor corresponding to an associated component, the sensors sensing when fluid is present at the component and providing a status signal.
